(19) United States
(12) Patent Application Publication
(10) Pub. No.: US 2022/0331618 A1
(43) Pub. Date: Oct. 20, 2022

(54) AVAAKA: ANTI-CONTAMINANT VENTING APPARATUS AND ANGELIC KANGA APPAREL

(71) Applicant: André V. Asselin, Welland (CA)

(72) Inventor: André V. Asselin, Welland (CA)

(21) Appl. No.: 17/721,623

(22) Filed: Apr. 15, 2022

Related U.S. Application Data
(60) Provisional application No. 63/176,441, filed on Apr. 19, 2021.

(51) Int. Cl. A62B 7/10; A62B 23/02; A62B 17/04; A62B 7/12

(52) U.S. Cl. CPC A62B 7/10; A62B 23/02; A62B 17/04; A62B 7/12

(57) ABSTRACT

A vented anti-contaminant device and more specifically to a wearable device incorporating a conduit network that uses sorption to protect users against viral, bacterial, fungal, protozoan, microbial, particulate, and xenobiotic contaminants is disclosed. In one embodiment, a wearable protective device, comprising: a breathing chamber; a conduit network attached to the breathing chamber at a first conduit network terminal portion such that the breathing chamber is in fluid communication with the first conduit network terminal portion; a second conduit network terminal portion of the conduit network in fluid communication with an air source; and a sorption structure within the conduit network is disclosed.

### CROSS-REFERENCE TO RELATED APPLICATIONS

This application claims the benefit under 35 U.S.C. § 119(e) of U.S. Provisional Patent Application Ser. No. 63/176,441, filed Apr. 19, 2021, entitled “AVAAKA: ANTI-CONTAMINANT VENTING APPARATUS AND ANGELIC KANGA APPAREL”, the entire contents of which is incorporated by reference herein.

### FIELD OF THE INVENTION

The present specification relates generally to a vented anti-contaminant device and more specifically to a wearable device incorporating a conduit network that uses sorption to protect users against viral, bacterial, fungal, protozoan, microbial, particulate, and xenobiotic contaminants.

### BACKGROUND OF THE INVENTION

The global pandemic caused by the severe acute respiratory syndrome coronavirus 2 (SARS-CoV-2 or COVID-19) has highlighted several issues with containing the spread of infectious agents, curtailing active cases, and ensuring that medical infrastructure is not overloaded to a point that primary healthcare services cannot be provided due to a lack of human capital and resources.

Key to addressing such a pandemic is the use of proactive and preventative measures. Social distancing, social isolation, quarantining, and various lockdown restrictions can help with managing the number of active cases but can lead to economic stagnation and personal hardship. In view of the crucial role social interaction plays in both the economy and personal health and wellness, the loss of social connectivity can have a profoundly negative impact on individual mental health and the economy. For example, social isolation mandates may prevent persons from visiting with family members in long-term care facilities or lockdowns restricting in-person business can disproportionately affect small businesses that rely on foot traffic and in-store sales. Nonetheless, such measures are crucial in ensuring that the risk of exposure to, and harm resulting from, an infectious agent is minimized.

Personal protective equipment (PPE) is another foundational part of proactive and preventative measures that is used where persons may be exposed to environmental contaminants. Among the prior art, there are several main types of respiratory protection devices.

Elastomeric facepiece respirators use removable or replaceable cartridges or filters and cover the nose and mouth to protect against gases, vapors, or particles when fitted with an appropriate cartridge or filter. Filtering facepiece respirators are the wholly disposable counterparts, wherein the facepiece itself acts as the filtration unit against particulate matter and the mask is to be discarded after use. Other forms of respiratory protection use a power or air source to provide uncontaminated air to a user. Powered air-purifying respirators, supplied-air respirators, self-contained breathing apparatuses, and combination respirators fall into this categorization. However, these forms of PPE may be limited by cost, fit, or effectiveness or create heating, condensation, air quality, or user mobility issues.

Accordingly, there remains a need for improvements in the art.

### SUMMARY OF THE INVENTION

In an embodiment of the present invention, there is provided a wearable protective device, comprising a breathing chamber, a conduit network attached to the breathing chamber at a first conduit network terminal portion such that the breathing chamber is in fluid communication with the first conduit network terminal portion, a second conduit network terminal portion of the conduit network in fluid communication with an air source, and a sorption structure within the conduit network.

According to further embodiments of the invention, the breathing chamber may be a hard-shelled headpiece embodied as an Anti-contaminant or Anti-viral Venting Apparatus (AVA) or a soft-shelled apparel structure embodied as an Angelic Kanga Apparel (AKA). AKA may incorporate moveable hoods or visors that can be reversibly positioned over a user's face.

Breathing chambers may be comprised of impermeable, semipermeable, or permeable materials and air may be delivered to a user at the back or side of the user's head, with an air intake aperture possibly being positioned at a distal location away from the user's head. Breathing chambers may be comprised of multiple layers with cavities containing air, supporting materials, or insulating materials therebetween.

A sorption structure includes a viral trap, a bacterial trap, a fungal trap, a protozoan trap, a microbial trap, a particulate trap, a xenobiotic trap, or a contaminant trap or any combination thereof. The sorption structure may be comprised of an adhesive, an obstruction element, a filter, a diameter narrowing element, a flow reversal conduit element, a high-surface area element, a silica gel, a zeolite, an activated carbon element, a desiccant, a protein, a nucleic acid, an antibody, a moiety, a functional group, a polymer, a virucide, an antibacterial chemical, an antimicrobial chemical, an anti-contaminant chemical, a chemical generating Van der Waals forces, a material generating electrostatic forces, a chemical with hydrophilic characteristics, a chemical with hydrophobic characteristics, a polar chemical, or a non-polar chemical. The sorption structure may be comprised of a plurality of sorption steps that create a sorption gradient to enhance filtration of contaminants and protection of a user.

Modularity in design of the breathing chamber, the conduit network, or the sorption structure can permit removal, replacement, and upgrading thereof with other parts, possibly in response to environmental circumstances and needs. An electromagnetic radiation source, sound wave generator, electrostatic element, or a diathermy element may be used to help deactivate or remove contaminants from air. Comprising the conduit network of opaque or reflective material can help protect the user from electromagnetic radiation and further reflect electromagnetic radiation within the conduit structure to improve sterilization or disinfection. Fluid flow control elements may also be incorporated.

An air bladder in fluid communication with the conduit network may be used to provide an air reserve or effect filtration. An air bladder may be compressible and may automatically restore itself to an expanded state while drawing in air post-compression.

The conduit network may be a single common conduit providing a bidirectional airflow path. The conduit network may alternatively be used in conjunction with an auxiliary conduit network to create a unidirectional airflow path.

Other aspects and features according to the present application will become apparent to those ordinarily skilled in the art upon review of the following description of embodiments of the invention in conjunction with the accompanying figures.

### BRIEF DESCRIPTION OF THE FIGURES

The principles of the invention may better be understood with reference to the accompanying figures provided by way of illustration of an exemplary embodiment, or embodiments, incorporating principles and aspects of the present invention, and in which:

FIGS. 1(a) to 1(d) show how social insulation may be achieved by using embodiments of the invention;

FIGS. 2(a) to 2(h) show AVA worn by users to provide social insulation, according to embodiments of the invention;

FIGS. 3(a) and 3(b) show AVA and AKA comprised of materials of different permeability, according to embodiments of the invention;

FIG. 4 shows AKA comprised of a combination of materials of different permeability, according to an embodiment;

FIGS. 5(a) to 5(c) show different pore sizes, shapes, and configurations, according to embodiments of the invention;

FIGS. 6(a) and 6(b) show locations of contaminant deposition in a conduit, according to embodiments of the invention;

FIGS. 7(a) and 7(j) show different means of effecting sorption in a conduit, according to embodiments of the invention;

FIGS. 8(a) and 8(b) show conduit curvature, according to embodiments of the invention;

FIGS. 9(a) and 9(b) show conduit air delivery pathways relative to a user's torso and head region, according to embodiments of the invention;

FIGS. 10(a) to 10(d) show contaminant filtration by sorption structures, according to embodiments of the invention;

FIGS. 11(a) to 11(c) show different types of sorption structures that may be used in filtration, according to embodiments of the invention;

FIG. 12 shows a conduit incorporating different means of sorption or contaminant deactivation, according to an embodiment;

FIGS. 13(a) to 13(i) show stabilizing contact areas that may be incorporated into embodiments of the invention;

FIGS. 14(a) to 14(d) show the locations of weight bearing contact areas and seals, according to embodiments of the invention;

FIGS. 15(a) to 15(d) show AVA and AKA being worn by users, according to embodiments of the invention;

FIGS. 16(a) and 16(b) show shell layering incorporating a conduit with a branched portion, according to an embodiment of the invention;

FIG. 17 shows shell layering incorporating a conduit and inter-shell cavities, according to an embodiment of the invention;

FIGS. 18(a) to 18(c) show a compression cycle of an air bladder containing filtering material, according to an embodiment;

FIG. 19 shows flaps and pouches being used in conjunction with tubular conduits and air bladders, according to an embodiment;

FIG. 20 shows airflow for a breathing chamber with a lower filtering area and deflector, according to an embodiment;

FIG. 21 shows an electromagnetic radiation source incorporated into a conduit, according to an embodiment;

FIG. 22 shows an AKA incorporating various accessories that assist with filtration, airflow, and protection of a user from contaminants, according to an embodiment;

FIG. 23 shows an AVA embodiment incorporating various accessories that assist with filtration and protection of a user from contaminants, according to an embodiment;

FIG. 24 shows an AVA comprised of a hard-shelled casing and an airflow conduit, according to an embodiment;

FIG. 25 shows an AKA resembling a series of hooded flaps affixed to apparel that are engageable to provide a soft-shelled encasing around a user's head, according to an embodiment;

FIG. 26 shows an AVA comprised of a clear upper facial area, a trapping portion, and air conduits, according to an embodiment;

FIG. 27 shows an AKA comprised of a clear upper facial area, a filtering lower facial area, tubing, and bladders, which may contain filters, according to an embodiment; and

FIGS. 28(a) to 28(d) shows an AVA embodiment that lacks sorption tubes.

### DETAILED DESCRIPTION OF EMBODIMENTS OF THE INVENTION

The description that follows, and the embodiments described therein are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly to depict certain features of the invention.

According to an embodiment, this description relates to a wearable protective device, comprising a breathing chamber, a conduit network attached to the breathing chamber at a first conduit network terminal portion such that the breathing chamber is in fluid communication with the first conduit network terminal portion, a second conduit network terminal portion of the conduit network in fluid communication with an air source, and a sorption structure within the conduit network.

According to embodiments of the invention, this description relates to the breathing chamber being a hard-shelled headpiece structure or a soft-shelled apparel structure. Furthermore, the soft-shelled apparel structure may be comprised in part of an adjustable hood structure that can be transitioned between an active encasing configuration and an inactive storage configuration. The breathing chamber may be comprised of impermeable, semipermeable, or permeable materials and the first conduit network terminal portion may be attached to the breathing chamber at a back portion of the breathing chamber or a side portion of the breathing chamber. The second conduit network terminal portion may be in fluid communication with the air source at a location distal to the breathing chamber. The breathing chamber may have a plurality of structural layers, between which is at least one cavity that may be an air pocket or contain a supporting material or an insulating material.

According to embodiments of the invention, the sorption structure may be a viral trap, a bacterial trap, a fungal trap, a protozoan trap, a microbial trap, a particulate trap, a xenobiotic trap, or a contaminant trap. The sorption structure may be comprised of an adhesive, an obstruction element, a filter, a diameter narrowing element, a flow reversal conduit element, a high-surface area element, a silica gel, a zeolite, an activated carbon element, a desiccant, a protein, a nucleic acid, an antibody, a moiety, a functional group, a polymer, a virucide, an antibacterial chemical, an antimicrobial chemical, an anti-contaminant chemical, a chemical generating Van der Waals forces, a material generating electrostatic forces, a chemical with hydrophilic characteristics, a chemical with hydrophobic characteristics, a polar chemical, or a non-polar chemical. The sorption structure may be comprised of a plurality of sorption steps that create a sorption gradient.

According to embodiments of the invention, the breathing chamber, the conduit network, or the sorption structure may be of a modular design. The wearable protective device may be further comprised of an electromagnetic radiation source element, a sound wave generating element, an electrostatic element, or a diathermy element within the conduit network and the conduit network may be comprised at least in part of an opaque material or a reflective material. There may be a fluid flow control element, like a valve, a vent, a pressure regulator, a motor, or other comparable fluid flow control element.

According to embodiments of the invention, there may be an air bladder in fluid communication with the conduit network. The air bladder may be further comprised of an air bladder sorption structure element within the air bladder or may be comprised of a compressible material that may generate an expansive force, which automatically returns the compressible material to an expanded configuration to draw in ambient air after compression.

According to embodiments of the invention, the conduit network may be comprised of a single common conduit to provide a bidirectional airflow path. The wearable protective device may further be comprised of an auxiliary conduit network attached to the breathing chamber at a first auxiliary conduit network terminal portion such that the breathing chamber is in fluid communication with the first auxiliary conduit network terminal portion, a second auxiliary conduit network terminal portion of the auxiliary conduit network in fluid communication with the air source, and an auxiliary sorption structure within the auxiliary conduit network, wherein the conduit network functions as an air intake pathway and the auxiliary conduit network functions as an air outlet pathway to provide a unidirectional airflow path from the second conduit network terminal portion through the conduit network, the breathing chamber, and the auxiliary conduit network to the second auxiliary conduit network terminal portion.

Framing the Need for Social Insulation

Respirators in the prior art can be grouped into two main categories, namely air purifying respirators like N-95 masks and air-supplied respirators like those found in diving gear. The former incorporates a filter as a means of blocking environmental contaminants from reaching a user's orifices and airways. In contrast, the latter provides an alternative or filtered air supply that is delivered to the user by a differential pressure system, with pressure differences arising from the use of compressed gas tanks or a powered, motorized fan.

While the prior art helps to address some problems posed by environmental contaminants, respirators in the prior art are limited by several major disadvantages.

The first is that of comfort and fit. The prior art generally uses a tight seal applied to a frontal part of the head, near or upon the facial area. Such a seal is created at a location responsible for many of the senses, such as sight, smell, or hearing and is susceptible to becoming dislodged, misaligned, or otherwise compromised as a result of normal body movements. For example, the inherent curvature of one's face or talking can cause separation between the point of contact for the respirator and the face. Users, consequently, become susceptible to airborne contaminants. In attempting to address these issues, respirators may incorporate straps or elastic attachments that create a securing force between the respirator and its points of contact on a user. However, such forces can cause discomfort, pain, and even skin damage or bruising. Carbon dioxide, water vapor, and heat buildup can exacerbate these discomforts, and further make such respirators unsuitable for use with many persons, especially those prone to irritation or hematomas.

Second, devices in the prior art create waste due to a reliance on disposable parts for operability. The recurring need to replace filters or cartridges to maintain functionality also adds to ongoing costs. Other devices incorporating supplied air sources require sedentary or mobile power sources, like batteries, to function or otherwise require compressed gas canisters. In the absence of filters, cartridges, compressed gas canisters, or a power source, these devices lose functionality and alternative protective measures must be used. Accordingly, users must regularly account for how long their supply of filters, cartridges, compressed gas, or power will provide protection and acquire and budget sufficient reserves to protect a user in their day-to-day operations. If demand for these disposable parts rises sharply, such as in response to a global health crisis, widespread shortages may result and the general public may then lack access to functional PPE. These limitations became especially evident throughout the COVID-19 pandemic, in that disposable PPE was in short supply to such an extent that persons reused disposable parts beyond their intended duration. In some cases, frontline medical personnel were without.

Third, respiratory devices in the prior art can create heating, condensation, and air quality concerns. Where devices lack a means of dissipating heat energy, users are susceptible to substantial discomfort and heat stroke, especially when used in warmer environments. Insufficient venting can cause the accumulation of moisture or contaminants, providing both an environment conducive to microbial growth and a directly elevated risk of exposure.

Fourth, the effectiveness of respiratory devices in the prior art is in part determined by conditions surrounding their use. The effectiveness of N-95 and other cotton masks in preventing environmental contaminants from entering a user's body is highly dependent on social isolation and distancing. The requirement to maintain a distance of approximately 6 feet or 1.83 meters between persons at all times significantly limits how these devices may be used. Such limitations put a strain on users, with some choosing to ignore proper use conditions or otherwise choosing not to use PPE at all. These use limitations are especially problematic in view of social organization or infrastructure that creates densely populated or high traffic areas, like downtown metropolitan centers or public transit vehicles, which inherently place persons into close contact with one another. Even when complying with best use practices, such PPE in the prior art can nonetheless fail to provide adequate protection in daily life.

Thus, there is a pressing need for simple, durable, reusable, and easy-to-wear devices that assist in safely surmounting the need for social distancing, social isolation, and quarantine restrictions.

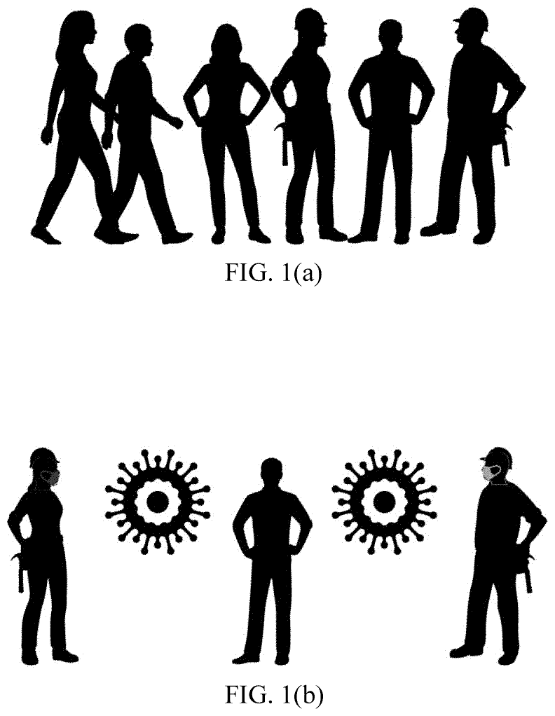

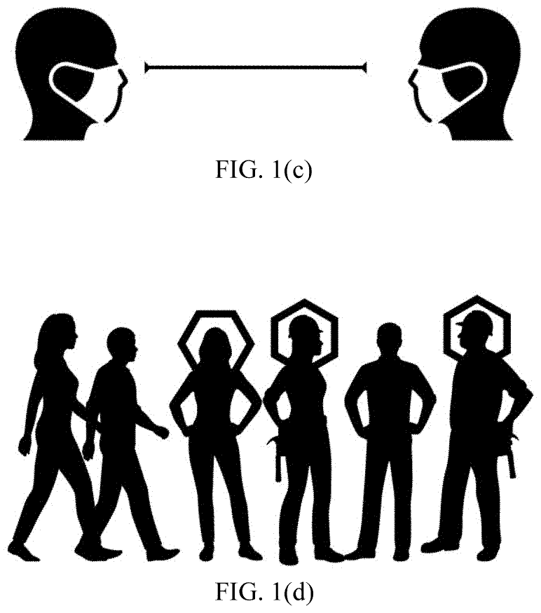

According to an embodiment, there is a filter and air delivery system that provides adequate air quantity and quality with respect to contaminant loads regardless of the distance between users and the characteristics of the contagion. According to an embodiment and as shown in FIGS. 1(a) to 1(d), wherein FIG. 1(a) shows normal social interaction and FIGS. 1(b) and 1(c) show social distancing measures, a condition coined “social insulation” is achieved as shown in FIG. 1(d) wherein users can safely overcome social distancing and isolation restrictions in a contaminated environment or an environment susceptible to contamination. Social insulation thereby permits individuals to be able to experience the close social contact that is integral to health, wellness, and a shared sense of community even during a pandemic.

According to an embodiment, there is a trapping element that traps contaminants or the suspensions, such as aqueous aerosols and droplets, associated with contaminant particles. According to a further embodiment, trapping occurs before air is inhaled into a user's body or from air after exhalation. According to an embodiment, trapping is facilitated by sorption, possibly in conjunction with airflow control measures arising from material composition, structure, and design. According to embodiments of the invention, simplicity is a guiding design principle, which may be incorporated in conjunction with design adaptability, modularity, reusability, cost effectiveness, a lack of motorized components, and fashion or aesthetic appeal.

Devising a Social Insulation Device

Features influencing the virulence of a contaminant and the spread of a pandemic include contagion strain, inoculum potential, population or contagion density, population or contagion distribution, duration of exposure, population age distribution, and the effectiveness of the anchoring elements on a contagion's exterior surface in attaching to a host. The inquiry process for social insulation thus accounted for social behavior linked to spread, notably super spreader events and global travel. With the main points of entry for contaminants being the mouth, nose through breathing, and eyes by touching, there is a pressing need to direct embodiments to these pathways to disrupt and minimize contaminant spread.

It is also important to account for shortfalls among the prior art. Masks, such as the N-95 mask, combined with social distancing have been a mainstream approach in reducing spread but create significant waste due to their disposable design and offer limited protection if not accompanied by appropriate social restrictions. Furthermore, these masks are predominantly directed to limiting the spread of a contaminant, as opposed to both limiting spread from contaminated parties and protecting uncontaminated users, and consequently offer an incomplete and inadequate anti-contaminant function. Encapsulating respirators that provide filtered air are also available but rely on battery operated motors or other power sources and disposable filters.

Diverse applications of tubes as conduits and filters can be found in biological systems. Hairs, cilia, and mucus have an important role in filtering dust particles from the air. As a conduit, an elephant's trunk permits air intake away from the head. Many fish express a unidirectional approach to breathing using a different entry point (the mouth) and exit (the gills), whereas squids use a looped conduit for breathing. Insects use spiracles for breathing, which bypasses the facial area entirely.

Nonetheless, the core inspiration for embodiments of the invention is Pasteur's swan neck flask, which was the iconic apparatus used in proving germ theory. Pasteur's swan neck flask is not considered a respirator for humans but can nonetheless be viewed as a type of air purifier that incorporates a tubular, curved design and an adsorptive surface to filter via gravitational forces. This flask supplies microbe free air to an inner chamber through a curved swan neck design that takes advantage of a minimal airflow exchange that permits gravity to act as the driving force to deposit microbes onto an inner surface of the glass comprising the swan neck.

Notably, the prior art lacks respiratory devices that directly incorporate filtration into a tubular structure. Respirators in the prior art have been grouped into two main categories, namely air purifying respirators like N-95 masks and air-supplied respirators like those found in diving gear. Respirator designs can also be grouped into three functional categorizations based on the degree of permeability found within the system and how that permeability influences protection from environmental contaminants.

The first category uses impermeable membranes to create self-sealed containers, such as in respirators for firefighters and in police riot gear, space suits, scuba gear, and other PPE that seals the face or head. Though used air may be exhausted for some of these devices, they are still functionally impermeable since the air supply is encased in pressurized tanks and a sealed internal chamber is created. Valves, vents, pressure regulators, motors, and other comparable elements may be incorporated to permit dynamic changes in permeability. For example, in scuba gear there is some permeability when air is released but the system is otherwise impermeable when air is drawn in during the pulsating breathing process. Space suits and spaceships may be considered a truly impermeable device where both the fresh and used air supplies are kept within an impermeable container.

Second, are respirators that incorporate semipermeable elements, like filters, to purify air. Common examples include gas, surgical, and cloth masks, but these devices are limited by the use of disposable filters that must be regularly replaced. These devices also must be used in conjunction with social limitations, like social distancing and isolation, to protect a user. While the use of semipermeable elements can help reduce the risk of exposure to a contaminant, these devices are still an imperfect solution due to their use limitations, which are at odds with a user's social needs or how populations are commonly organized.

The third functional category incorporates open or permeable elements. These devices may have an air conduit or channel but, with the exception of Pasteur's swan neck flask, do not use a tubular structure as a filter. Within this category are devices like deep-sea helmets and snorkels.

According to an embodiment, impermeable, semipermeable, or permeable elements may be incorporated to facilitate air supply, navigate airflow, effect filtration, or protect a user. In this regard, it is an objective of embodiments of the invention to remove or reduce the need for social distancing, social isolation, quarantines, or other restrictive orders in combating a pandemic or in protecting users from environmental contaminants. Thus, embodiments of the invention create a state of social insulation, wherein users are protected from contaminants in a manner that allows for healthy social interaction and which minimizes disruption to regular economic activity.

According to an embodiment, the air intake conduit and air outlet conduit may be the same structure. In embodiments where the air intake conduit and air outlet conduit are the same structure, bidirectional airflow occurs within a common conduit. According to an alternative embodiment, the air intake conduit and air outlet conduit may be different structures. In embodiments where the air intake conduit and air outlet conduit are different structures, linear airflow occurs from the intake conduit to the outlet conduit.

According to embodiments of the invention, biological aspects of respiration may be replicated or mimicked in structure or design. Such biological aspects may include, but are not limited to, the linear flow found in fish breathing wherein the mouth acts as an inlet and the gills as an outlet, the lateral bidirectional flow found in insect spiracles, and the filtering conduit structures found in an elephant's truck, the swan neck, respiratory tracts, digestive tracts, or other biological conduits.

Embodiments of the invention may also incorporate treatments found in other fields that may involve fluids, space suits or equipment, industrial air filters, drainage tiles, and other fields that may be applicable or synergistic to sorption or filtration. Embodiments of the invention may incorporate silica gel, zeolites, activated carbon, desiccants, proteins, or polymers to help with sorption or filtration.

According to an embodiment, contaminant particles or the suspensions associated therewith, such as aqueous aerosols and droplets, are trapped through sorption during a breathing cycle of a user. Herein, sorption refers to the use of either absorption or adsorption to effect trapping.

According to embodiments that use absorption, the particle or associated suspension acts as the adsorbate and is dissolved or permeates an internal volume of an embodiment of the invention, which acts as the absorbent. According to embodiments that use adsorption, the particle or associated suspension acts as the adsorbate and is adhered to a surface of an embodiment of the invention, which acts as the adsorbent. According to an embodiment, sorption occurs as air travels through a tube, channel, conduit, or cannula.

According to an embodiment, sorption of a contaminant or associated suspension creates social insulation, wherein users can overcome social distancing and isolation during a viral pandemic or other environmental circumstances that present a risk of exposure to a contaminant. Social insulation may be achieved by filtering inhaled or exhaled air, such that sorption on air intake removes environmental contaminants to minimize the risk of exposure to the user and that sorption on exhalation minimizes the risk of a user releasing contaminants into an environment.

Embodiments of the invention are effective in removing contaminants from the air prior to breathing and breathing and body motion may facilitate or assist with driving airflow, thereby removing the need for motorized parts, like mechanical fans. Embodiments may be modular, adaptable, reusable, low maintenance in general and especially in washing or recharging, hard or soft sealed, have no contact with the facial area, and treat air prior to or during breathing. According to an embodiment, a large filtering surface area or volume may be incorporated to maximize air filtration by sorption. According to an embodiment, air may be transported by tubular conduits such that air is passed through filters. According to an embodiment, seals may be created near the shoulder and neck area of a user or near the waist and wrist area of a user and may be snug and comfortable, but not overly tight. According to an embodiment, there is little to no contact between a user's facial area and a device, with the weight of the device instead being distributed onto the user's head or shoulders. According to an embodiment, body motions like movement of a user's hand, arm, or legs may assist in drawing in and pumping air to a user or in venting exhaled air. According to an embodiment, specialized tubular structures may be incorporated not only as conductive channels, but also as filtering elements.

According to an embodiment, there is a modular structure and design that may be adapted to address new situations and developments, like new strains of environmental contaminants. According to an embodiment, there may be multiple filtration steps that may create a filtration gradient. According to an embodiment, modularity in structure and design may be used to create sequenced and specialized filtration steps.

According to an embodiment, an air bladder or air pocket may be incorporated to assist with air supply to a user. These air bladders or pockets may act as air reserves and may assist in drawing air into the system or releasing air to a user. According to a further embodiment, air bladders or air pockets may have a self-filling mechanism wherein the air bladder or pocket automatically draws air into itself. According to an embodiment, an air bladder or air pocket may be manually compressed by a user to release air contained within the air bladder or pocket.

According to an embodiment, filtering elements of a device may be washable or rechargeable. In this respect, the filtering elements are reusable and are longer lasting than disposable filters found in the prior art. According to an embodiment, the filtering elements of a device may be comprised of a material or, either alone or in combination with other parts of the device, of a structure or design that permits the filtering elements to be easily removable for washing or recharging.

According to an embodiment, filtered air may enter an internal chamber defined by the device at a location away from a user's face when in use. According to an embodiment, air may be filtered over one or more breathing cycles before entering a user's body.

Anti-Contaminant Venting Apparatus (AVA) and Angelic Kanga Apparel (AKA)

Social insulation may be provided by Anti-contaminant or Anti-viral Venting Apparatus (AVA) or Angelic Kanga Apparel (AKA) embodiments that assume different forms, but which nonetheless protect users from environmental contaminants.

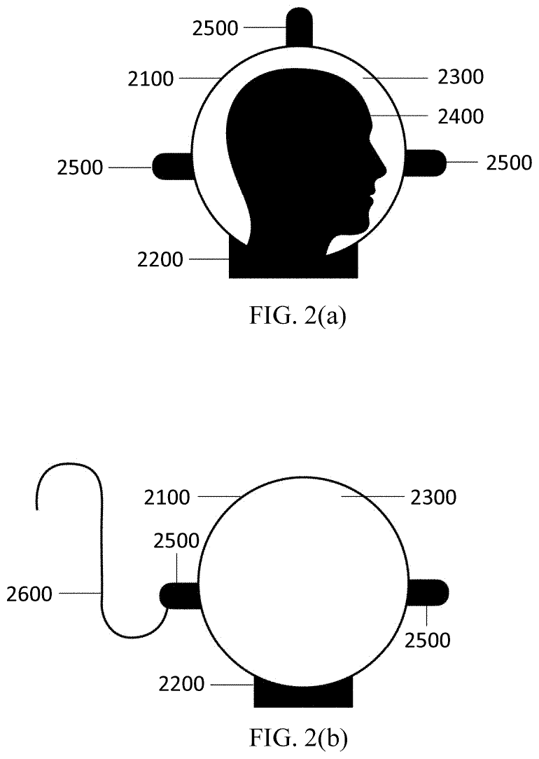

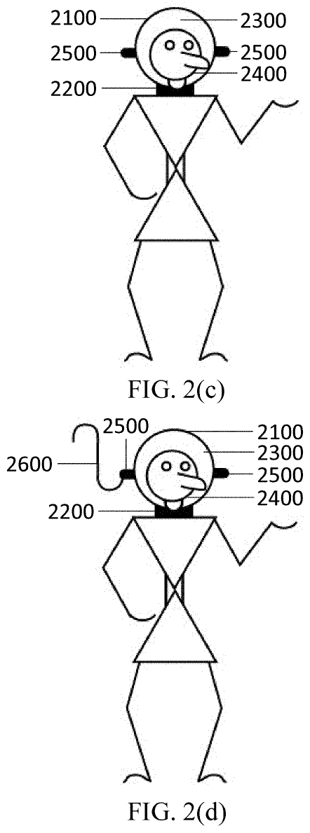

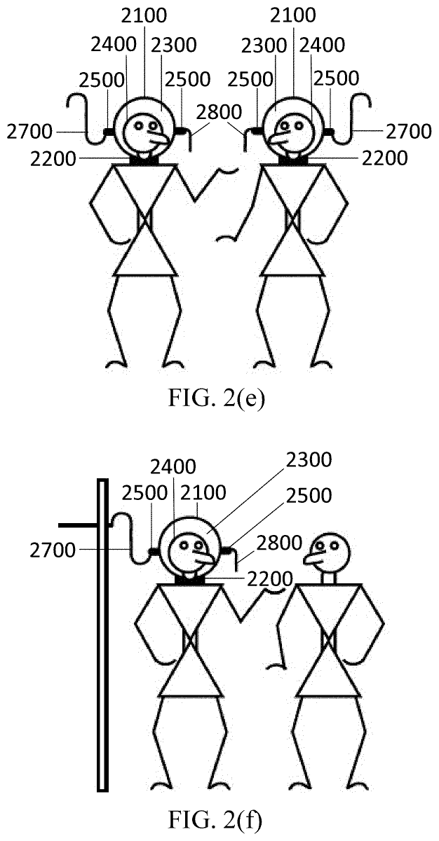

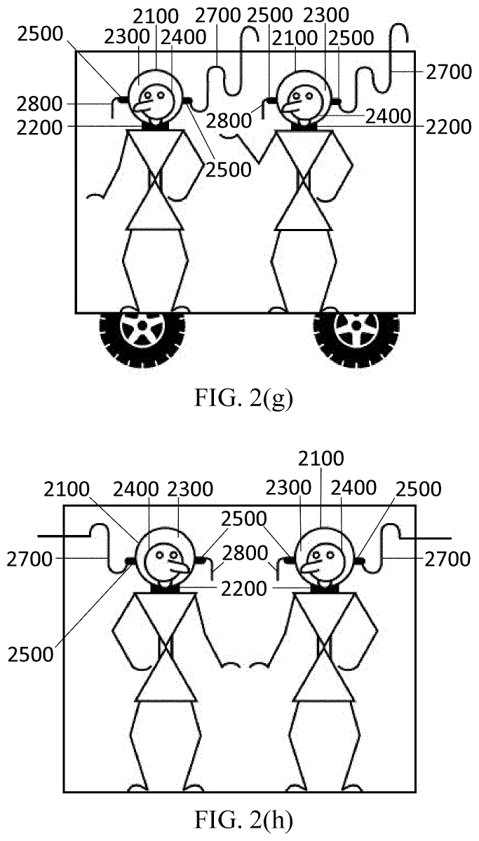

According to AVA embodiments shown in FIGS. 2(a) to 2(h), there is an approximately spherical helmet 2100 with a collar 2200 and shoulder harness which create an internal breathing space 2300 for a user 2400. Tubular projections 2500 represent valved intake or outlet conduits that may facilitate unidirectional or bidirectional airflow or which may be operated to transition between an open and closed configuration. Social insulation provided by embodiments of the invention can permit general safety and closeness as shown in FIG. 2(e), safe contact with members of the public as shown in FIG. 2(f), safe use of public transit vehicles like buses or trains as shown in FIG. 2(g), or safe close encounters in business circumstances or meetings as shown in FIG. 2(h).

Embodiments may be used to assess contaminant deposition, wherein it might be anticipated that contaminant particle density and distribution will be highest around the mouth and nasal area when only a front valve is open whereas contaminant particle density may be anticipated to be more evenly distributed around the top and back of the head when the front valve is closed. Embodiments may also allow other pragmatic considerations to be tested, like the apparatus-body seal, potential for suffocation, oxygen deprivation, temperature regulation, condensation, efficiency of filtering materials, and tube size, length, and configuration.

According to the embodiment shown in FIG. 2(b), a bidirectional airflow tube 2600 may be incorporated to permit air intake and venting at a location away from the spherical helmet 2100. According to the embodiments shown in FIGS. 2(d) to 2(h), intake tube 2700 may be flexible or rigid and assume a variety of different shapes. For example, an intake tube 2700 may be curved at its top to prevent rain from inadvertently entering the intake tube 2700 and internal breathing space 2300. As shown in FIGS. 2(e) to 2(h), outlet tube 2800 may be of varying length and may be valved or filtered to allow for optimal contaminant trapping.

According to an embodiment, a modular design permits the addition, removal, or variation of parts comprising AVAs such that filtration properties may be enhanced or otherwise adapted to protect against specific contaminants. According to an embodiment, the material comprising the inner surface of the spherical helmet 2100, the tubular projections 2500, bidirectional airflow tube 2600, intake tube 2700, or outlet tube 2800 may have adhesive, electrostatic, or other attractive, capturing, or securing qualities or properties.

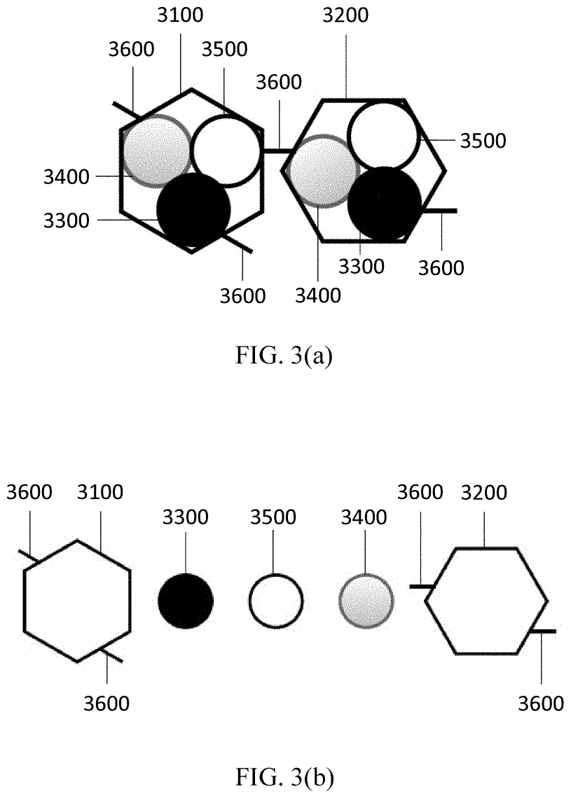

According to embodiments shown in FIGS. 3(a) and 3(b), AVAs and AKAs may be used in conjunction with materials of varying degrees of permeability and conduits to create social insulation. In such embodiments, an AVA component 3100 may act as a helmet-like structure in combination with a wearable AKA component 3200. Impermeable 3300, semipermeable 3400, and open permeable 3500 structures may be incorporated to exclude contaminants or filter air using sorption on uptake or venting. Conduits 3600 may be incorporated to facilitate air uptake or venting, or otherwise permit airflow between the AVA component 3100 and AKA component 3200. Conduits 3600 may also incorporate impermeable 3300, semipermeable 3400, or open permeable 3500 structures to assist with excluding or filtering contaminants. According to a further embodiment, a modular design permits variation and adaptability to circumstantial needs through interchanging any of the AVA component 3100, the AKA component 3200, impermeable 3300 structure, semipermeable 3400 structure, open permeable 3500 structure, or conduits 3600. According to another further embodiment, the AVA component 3100 may be of a hard-shell helmet design and the AKA component 3200 may be of a soft-shell garment design that may be similar to hooded apparel that permits reversible covering of the head.

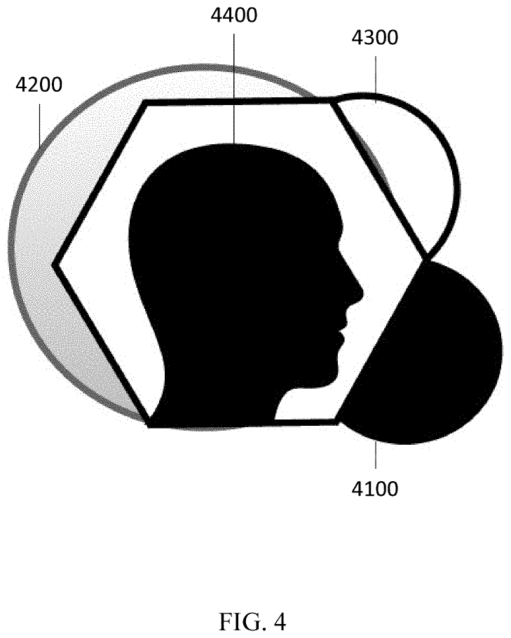

According to an embodiment shown in FIG. 4, AKA may be wearable apparatuses, like clothing, and comprised of materials of varying degrees of permeability and may incorporate conduits to create social insulation. In such embodiments, impermeable 4100, semipermeable 4200, and open permeable 4300 structures may be incorporated to exclude contaminants or filter air using sorption on uptake or venting. An AKA embodiment may be designed such that the AKA does not contact the facial area of the user 4400. According to an embodiment, semi detachable flaps are incorporated which may be reversibly positioned in front of a user's face in response to circumstantial triggers. For example, such a reversible flap may be moved into an active protection position in front of a user's face to exclude or filter airborne contaminants in response to a user entering a contaminated location.

According to an embodiment, AKA promotes linear airflow through the fabric comprising the apparel, with the comprising material acting as a large filter. According to a further embodiment, the back area of the AKA acts as a filter, like a cotton filter, and air intake may occur at an upper portion of the back area of the AKA with air venting occurring at a lower portion of the back area of the AKA. Embodiments with a large surface area for gas entry can improve filtering capacity and efficiency. Embodiments may also be supplemented by filtering conduits. Among AKA embodiments, filtration of exhaled air may also occur to prevent contaminant transmission by asymptomatic persons.

According to an embodiment, a frontal area of AKA is at least partly impermeable and, possibly, wholly impermeable. According to an embodiment, portions of the frontal area of AKA may be approximately transparent or translucent such that a user can clearly see out of the AKA.

Filtration and Conduit Considerations

According to an embodiment, impermeable materials are incorporated to prevent air from moving through a structural matrix. According to a further embodiment, impermeable materials may be used to comprise rigid shell structures or conduits. In this regard, impermeable materials can define internal cavities, channels, or other sectioned volumes or be used to create partitions within such spaces.

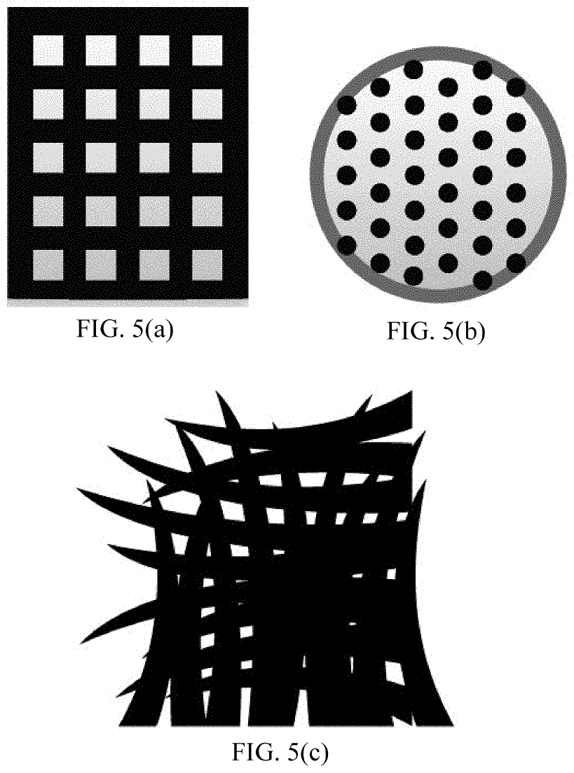

According to an embodiment, semipermeable materials are incorporated so that particles and vapors are dissolved in, permeate, or are otherwise absorbed within the semipermeable material's volume or matrix. In this regard, the semipermeable material acts as a trap that prevents contaminants from migrating from a first location, like an external environment, to a second location, like an internally defined breathing space created by an embodiment. According to further embodiments and as shown in FIGS. 5(a) to 5(c), pore size, shape, and configuration influences filtration effectiveness and capacity and may be considered in conjunction with fluid flow, like airflow, to optimize filtration efficiency or capacity.

According to an embodiment, open permeable materials may be incorporated that trap contaminants on a surface thereof by adsorption. In this regard, adsorptive surfaces may act as a trap that removes contaminants from a fluid with the remaining elements of the fluid still passing freely through a conduit. In application, this effectively filters out airborne contaminants without impeding a user's oxygen supply.

According to an embodiment, wicking elements may be incorporated to trap the aqueous aerosols or droplets associated with contaminant particles. According to an embodiment, absorptive filters may also contain adsorptive material, as is the case with a filter comprised of charcoal.

According to an embodiment, the inhalation and exhalation cycles of breathing creates a pulsating process that is used in conjunction with filters to optimize design, structure, effectiveness, and capacity of respiratory protection. According to an embodiment, adsorptive filtration is enhanced during the air stillness between inhalation and exhalation in a user's breathing cycle. Modularization in the design and structure of embodiments also permits users to adapt sorption characteristics to a user's breathing cycle in optimizing filtration or in creating graded filtration stations.

According to an embodiment, an intake conduit may be positioned such that air intake occurs at a location away from the head or facial area of a user. According to a further embodiment, an intake conduit may terminate and release air at the back or sides of a user's head.

According to an embodiment, an air chamber or bladder may be incorporated to provide greater filtration time or to provide an air reserve. According to a further embodiment, air chambers or bladders may be integrated into a shell structure to allow body movement to act as a supplementary air pump. In this regard, the need for an electric motor in driving airflow is bypassed.

With respect to conduit design and structure, it is important to note that absorptive filtration benefits from air being forced through a semipermeable structural matrix. Adsorptive filtration benefits from air stillness, an effective adsorptive surface, and properties that create proximity or attractive forces between the adsorptive surface and a contaminant. According to an embodiment, gravity, Van der Waals forces, Brownian motion, and electrostatic attraction may be used to create and enhance filtration.

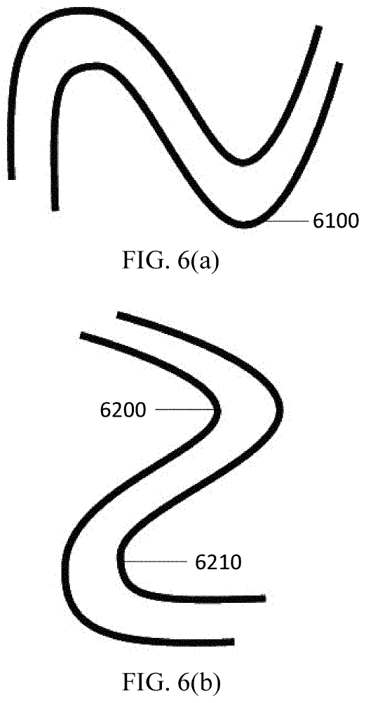

According to an embodiment shown in FIG. 6(a), which represents a swan neck flask configuration, contaminant deposition is expected to be highest at lower curve 6100 of a conduit wherein lower curve 6100 is the lowest vertical point of the conduit. According to an embodiment shown in FIG. 6(b), contaminant deposition is expected to be highest at inner bends 6200 and 6210 of a conduit wherein fluid flow sediments contaminants as the fluid is channeled around inner bends 6200 and 6210. A helpful analogy for the embodiment shown in FIG. 6(b), would be to think of the conduit as a river and the inner bends 6200 and 6210 as points whereby the flow of river water would effect erosion. Since the design, structure, positioning, and overall shape of conduits can influence filtration effectiveness and capacity, these features are relevant to and accounted for in determining the inner shape of a conduit.

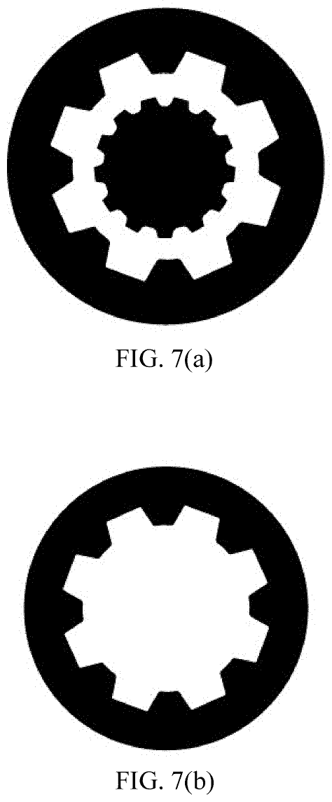

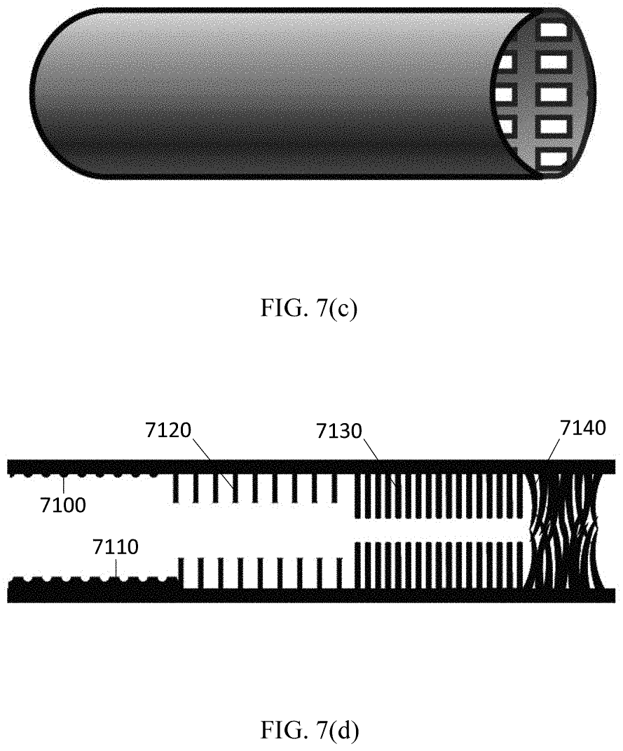

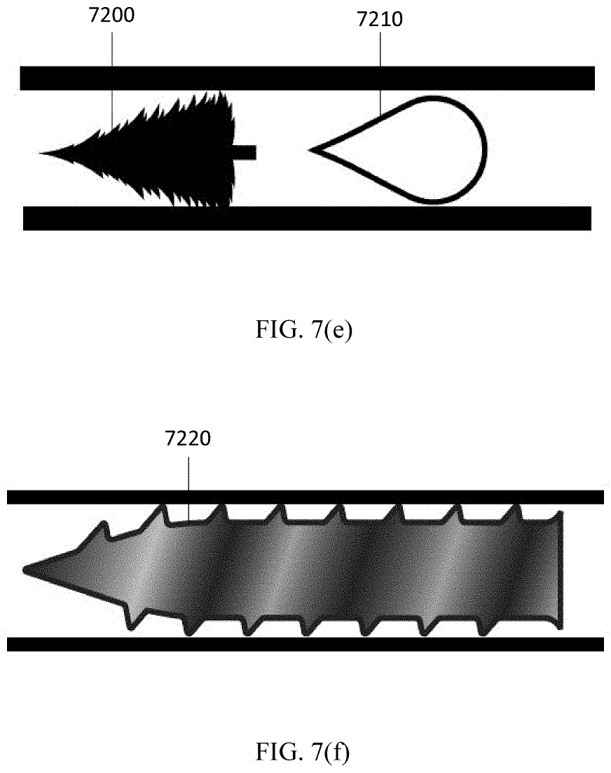

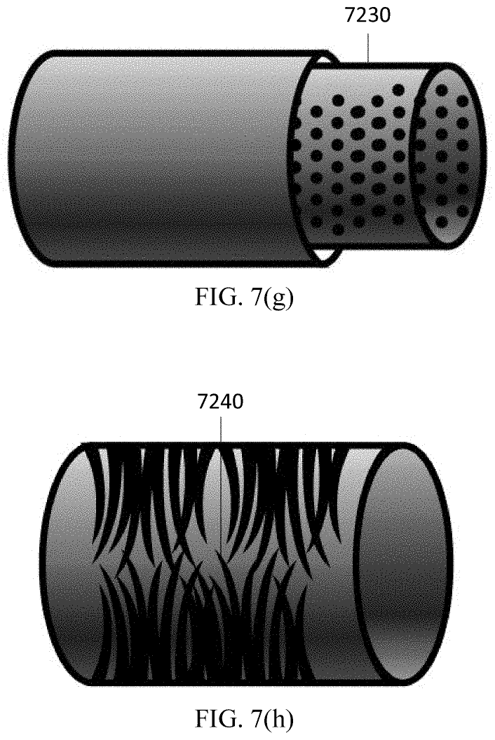

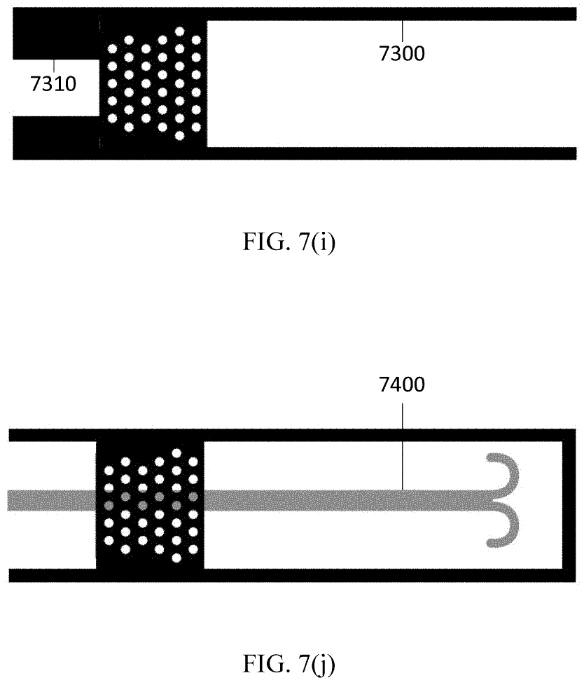

According to embodiments shown in FIGS. 7(a) and 7(b), inner conduit structure can be modified to create areas of high and low flow benefiting absorption and adsorption, and thereby filtration. According to an embodiment shown in FIG. 7(c), inner conduit structure can combine impermeable, semipermeable, and permeable elements for fluid filtration and transport. According to an embodiment shown in FIG. 7(d), gradient filtration may be created using multiple filtration stations comprised of internal filtering elements 7100, 7110, 7120, 7130, and 7140. According to embodiments shown in FIGS. 7(e) to 7(h), obstructions 7200, 7210, 7220, 7230, and 7240 may be incorporated to create high pressure streamlined areas for absorption and low pressure chaotic areas for adsorption. According to an embodiment shown in FIG. 7(i), conduit diameter may be adjusted to effect pressure changes to create a filtration station, in that there may be within a conduit both a wide diameter portion 7300 and narrow diameter portion 7310. According to an embodiment shown in FIG. 7(j), there may be a reversal conduit element 7400 positioned within a conduit to assist with filtration or conducting fluid flow.

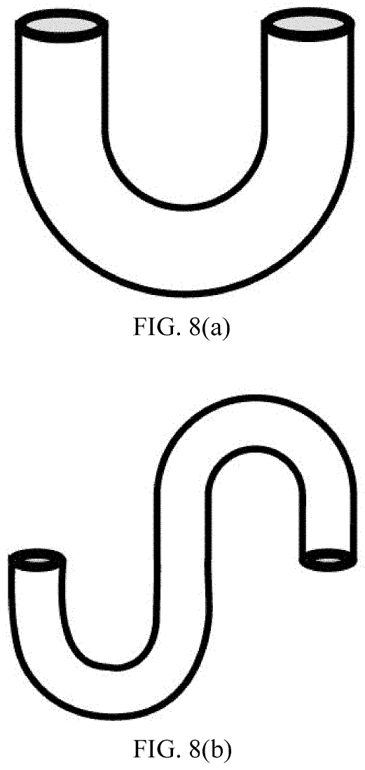

According to an embodiment, curves may be incorporated into the design or structure of conduits to assist with filtration or conducting fluid flow. According to embodiments of the invention, curves may be incorporated into the design or structure of conduits to provide an approximately U-shaped configuration, like as shown in FIG. 8(a), or an approximately sigmoid shape, like as shown in FIG. 8(b).

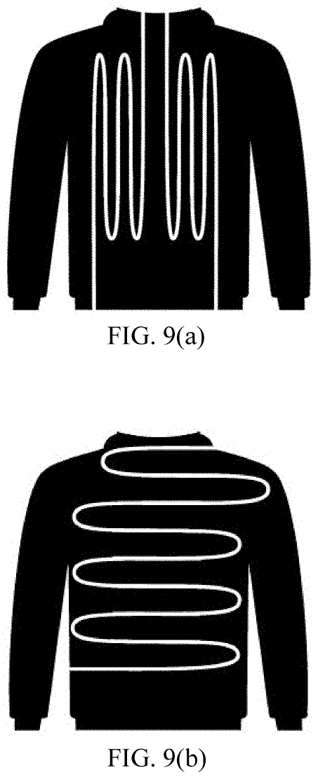

According to an embodiment, conduits can be incorporated within apparel. These embodiments constitute AKA and may replicate or mimic biological aspects of respiration by allowing air to be drawing into the conduit at a location away from the head or facial area. According to embodiments shown in FIGS. 9(a) and 9(b), conduits may be located along the lateral lines of the torso or across the back and abdomen and terminate near or at a user's head.

According to an embodiment, air inflow or outflow is balanced between intake or outlet conduits or the garment itself where the garment is comprised at least in part of semipermeable or permeable material. According to an embodiment, seals for a garment portion may be around the waist and wrists or otherwise at a location away from the head or facial area. Embodiments wherein the point of entry for air is located away from the internal breathing space defined by the apparatus or apparel help with isolating air prior to breathing and allows for longer filtration times at least in part due to the longer pathway air must travel before reaching a user.

According to an embodiment, materials or a user's body may be treated with a virucide, antibacterial, or other antimicrobial or anti-contaminant compound to help protect users. Embodiments of the invention may be washable or rechargeable or comprised of washable or rechargeable elements. Modularity in design and structure permits the elements comprising an embodiment to be separated from one another such that different elements may be washed, recharged, or treated according to their use or role in protecting a user. According to an embodiment, an ultraviolet (UV) radiation source is incorporated to help sterilize or disinfect air as it travels through a conduit. According to a further embodiment, the UV radiation source is at least one UV light emitting diode (LED) or may be a low-pressure mercury lamp, a high-pressure mercury lamp, or an excimer lamp. According to another further embodiment, both UV irradiance and duration of exposure to UV radiation are used to calculate a disinfecting dose for a volume of contaminated air. Conduit length may then be adjusted to provide a retention time for contaminated air that is sufficient to deliver the identified disinfecting dose. In doing so, the structure and design of conduits may also account for airflow rate.

According to an embodiment, a sonic generator is incorporated to general sound waves at a frequency that disrupts receptors on viral particles, bacteria, or other contaminants or otherwise deactivates such contaminants. According to an embodiment, an electrostatic element or a diathermy element may be used to effect adsorption of contaminants. According to a further embodiment, the electrostatic element may generate static electricity as a user moves, which may be used to facilitate sorption.

Optimizing Sorption Characteristics

In embodiments of the invention, different physical or chemical interactions may be used to effect filtration. In determining which physical or chemical interactions are most appropriate to incorporate into an embodiment to protect against a particular contaminant, it is crucial to understand the physical or chemical properties of, or associated with, a contaminant.

Contaminant particles may be introduced into an environment by exhaled air from a contaminated individual, such that contaminant particles are suspended in water contained within the exhaled air. Water in the form of aqueous aerosols and droplets exhaled by individuals may act as a vehicle of transmission for contaminants. In this regard, the physical or chemical properties of water may help facilitate contaminant spread. These properties include the polarity of water, such as the existence of δ⁺ or δ⁻ dipoles and the presence of hydrogen bonding. Water is also an especially strong and universal solvent with strong adhesive and cohesive properties, strong capillary action, and strong surface tension. Accordingly, these properties may be used to guide the design of filtration systems, especially with respect to the selection of material comprising a filtration system and pore size.

In this regard, a combination of both absorption and adsorption is used to create a synergistic effect that minimizes the likelihood of exposure to contaminants. According to an embodiment, conduits and holding chambers may be used to take advantage of the pulsing breathing cycle of inhalation and exhalation, along with the pause therebetween. According to an embodiment, ions or molecules comprising or fixed to an inner surface of a conduit may be used to effect adherence or bonding of contaminants through adsorption. Hydrophilic solids may be especially useful in this regard since they can readily attract water and use polar interactions to partition water, like aqueous aerosols, into the solid even in relatively low humidity.

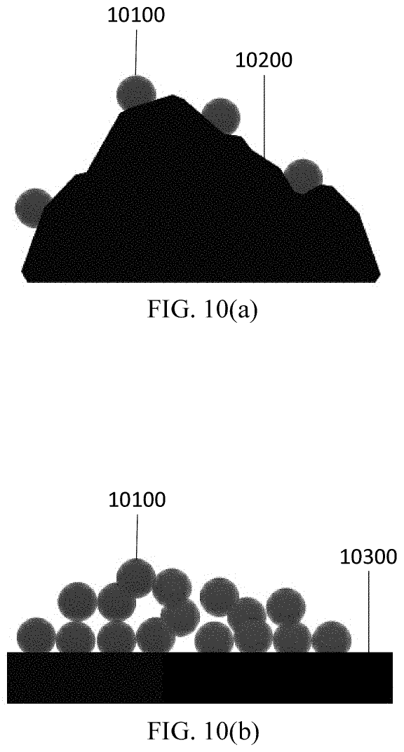

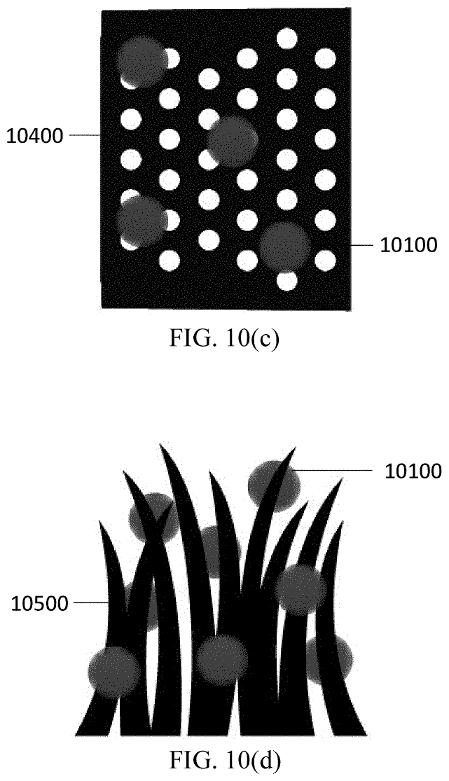

According to an embodiment, adsorbing materials may be harder materials, like glass, activated charcoal, zeolites, or silica, whereas absorbing materials may be softer materials, like cotton, sponge, or textile fibers. According to embodiments of the invention, sorption may occur by contaminant 10100 deposition on coal 10200 as shown in FIG. 10(a), on glass 10300 as shown in FIG. 10(b), on a sieve 10400 as shown in FIG. 10(c), or on fibers 10500 as shown in FIG. 10(d).

Embodiments may be further distinguished based on the sorption process itself. Embodiments may rely on impact absorption to filter air prior to entering the body or incorporate a volume of adsorptive material, such as activated charcoal, in a filter. Impact sorption itself results from differences in air pressure during a breathing cycle, which allows filtration of air coming into and out of the body. Other embodiments may use electronics, albeit the primary design principle for embodiments of the invention is to be motorless and not dependent on an artificial energy source. These aforementioned embodiments may benefit from a unidirectional airflow path.

Sorption in embodiments also benefits from air stillness and reduced airflow, which allows Brownian motion, Van der Waals forces, electrostatic attraction, and gravity to drive the adsorption process. Respirators in the prior art do not effectively capitalize on these means of filtration, but one apparatus, Pasteur's Swan Neck Flask, does illustrate the effectiveness of adsorption regarding microbes in a very simplistic system.

Furthermore, the prior art does not actively integrate the collection and storage of air as part of the filtration process. Some respirators, like scuba gear, incorporate a limited supply of pretreated (compressed) air, which limits their duration capacity. Supplied air respirators, by contrast, are limited by the length of the tube and require a motorized compressor to function.

Accordingly, embodiments may incorporate air bladders or chambers that can enhance adsorption by creating relative air stillness. Tubular structures are especially suitable for capitalizing on this by acting as both as a storage chamber in addition to a delivery conduit.

Furthermore, breathing is a tidal cycle, with inhalation, a pause, then exhalation, and the natural air intake and outlet conduits of persons, namely the mouth and nose, are effectively one and the same. Embodiments may thus use a shell encompassing the user to distinguish between air outlet(s) and means of air intake. This distinction allows a substantial portion of the shell itself to become an absorbing filter. By further incorporating tubes and chambers into the shell and intake process, air may be collected and filtered by adsorption during the breathing pause that results from an overall linear airflow design.

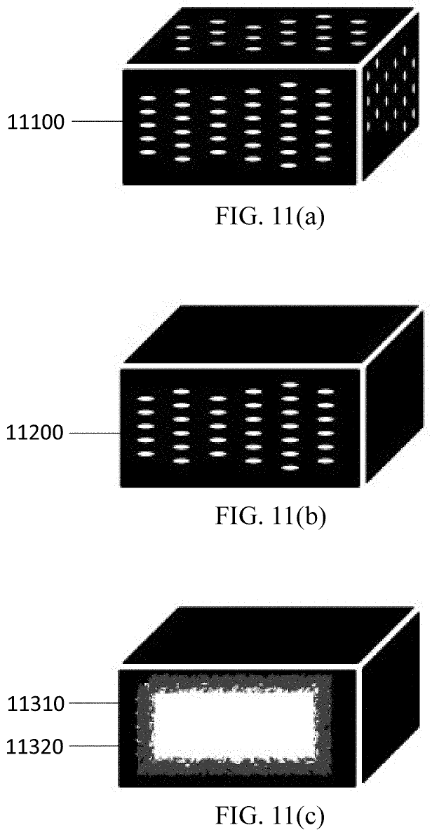

According to embodiments shown in FIGS. 11(a) and 11(b), absorption may be facilitated using a sponge 11100 or a rectangular tube with an absorptive filter 11200. According to the embodiment shown in FIG. 11(c), a hollow rectangular tube 11310 may be used in conjunction with an inner adsorptive surface 11320 to effect adsorption. Nonetheless, different means of sorption may be combined in a single structure or separate modular structures to provide filtration and protection from contaminants.

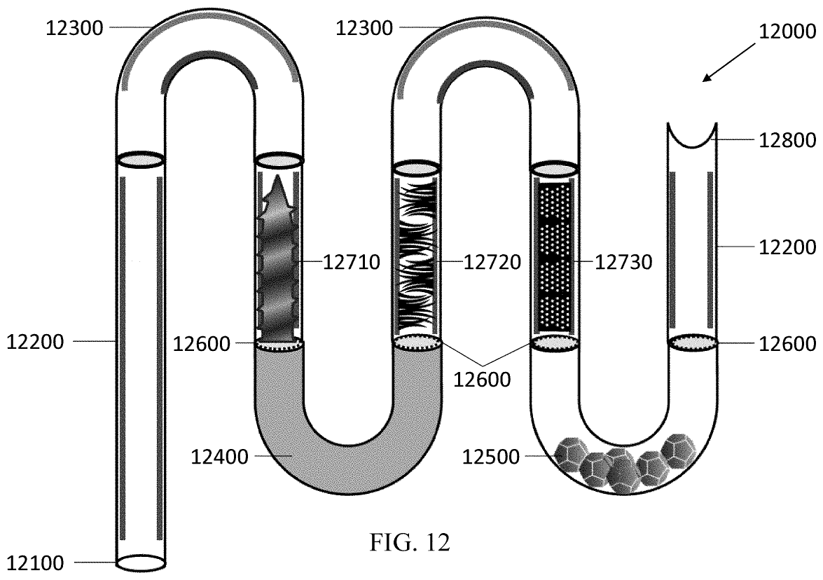

According to an embodiment shown in FIG. 12, sorption may be effected through the use of a sorption conduit 12000 comprised of various modular structures that either individually or in conjunction with one another trap, obstruct, kill, deactivate, or otherwise prevent contaminants from reaching a user. Further, an entrance 12100, possibly near a user's waist area, acts as the starting point for the sorption conduit 12000 and may define a periphery abutting an outside shell, air bladder, or body operated pump. A straight tube area 12200 may follow, with upper curved tube areas 12300 creating turning points that both connect components of the sorption conduit 12000 and compact the overall sorption conduit 12000 structure to assist with portability and integration into wearable apparatuses. Lower curved tube areas may incorporate a liquid 12400 that is a virucide, bactericide, or other liquid phase anti-contaminant agent. Lower curved tube areas may incorporate solid phase filtration elements 12500, like silica beads, zeolites, or activated carbon, to permit absorption of, for example, water-housing contaminants. Filter or valve points 12600 permit multiple filtration stations to create a gradient approach and also help facilitate an accessible and modular design. Various inserts 12710, 12720, or 12730 may provide reticulation in the sorption conduit 12000 to further enhance sorption. Exit 12800 marks the termination of the sorption conduit 12000 and permits filtered air to enter a head area. According to an alternative embodiment, a portion of the sorption conduit 12000 may incorporate an irradiating element. Such an irradiating element may be a UV light and may be incorporated as a flexible UV bulb or a tube within a tube housing that has an opening to facilitate airflow. The irradiating element may further be shielded with a reflective material, like aluminum foil, to assist with irradiation of contaminated air upon intake or in venting.

Wearability Considerations and Shell Layering

According to an embodiment, AVA may be a hard-shell, like a helmet comprised of plastic or fiberglass that can have tubing terminating near a user's head area. Such termination may occur close to, but not directly at a user's face, like at the top or sides of a user's head. Intake areas may be at the back of the head, preferably at a neck region or collar of the helmet. In these embodiments, delivery conduits may tend to be shorter than in AKA embodiments since the driving principle is to draw air from the rear of the body towards the top or sides of the user's face. Since the conduits may be relatively shorter, stronger filtration elements are incorporated to compensate for the shorter travel path and travel time. Embodiments with hard-shell structures also permit conduits to be flattened, so as to be integrated into the hard-shell structure itself. According to a further embodiment, a shell structure may have vents and grooves, possibly in low-visibility locations, where tubes may be integrated. According to an alternative embodiment, AVA may be used in conjunction with common clothing, like a sweater, to provide a hard-shell helmet, soft-shell clothing system wherein conduits are not incorporated into the garment as would be the case in AKA embodiments. Such embodiments with non-integrated conduits may nonetheless permit users to tuck, clip, or otherwise attached or secure the non-integrated conduits to a portion of the common clothing article.

According to an embodiment, AKA may include pouches that house conduits. These pouches may be comprised of fabric or a lining of material with hook and loop fasteners that can be opened to access conduits.

According to an embodiment, AVA may be a hard-shell structure with short conduits or long conduits or use reversibly attachable conduit extensions that may be reversibly secured to short conduits directly attached to the AVA to extend the length of a tubular network. In AVA embodiments with long conduits or that make use of reversibly attachable conduit extensions, the long conduits or conduit extensions may terminate in an area away from a user's face, like near the waist or belt area of a user. In embodiments that incorporate both AVA and AKA structures at least in part, the long conduits or reversibly attachable conduit extensions may be covered by a soft-shell AKA structure, like a soft sweater, to help make the AVAAKA system suitable for use in cold weather. Embodiments incorporating AKA structures may also feature soft-shell tubes incorporated into the shell and which are accessible, if needed, via pouches. In this regard, the distinguishing features of AVA and AKA embodiments, namely, a hard structural shell component for the head in the case of the former and a soft-shell structural component for the latter, may be combined.

Furthermore, in designing embodiments that incorporate a head component, the manner in which the head component is secured to a user's head and the location of seals is especially important to both comfort and functionality.

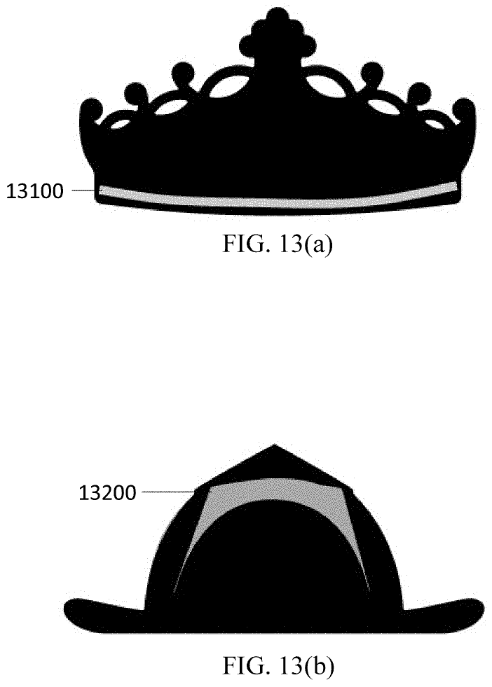

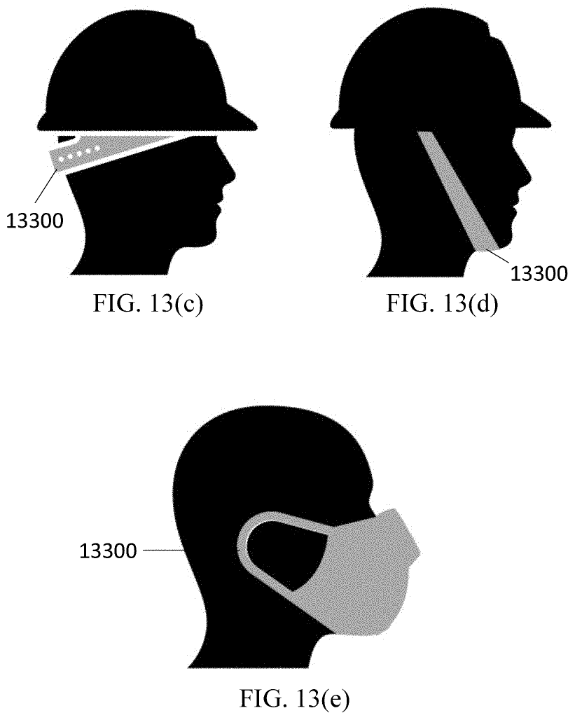

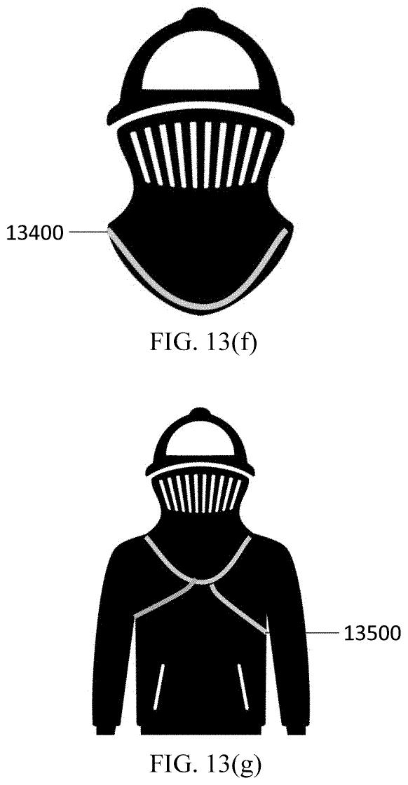

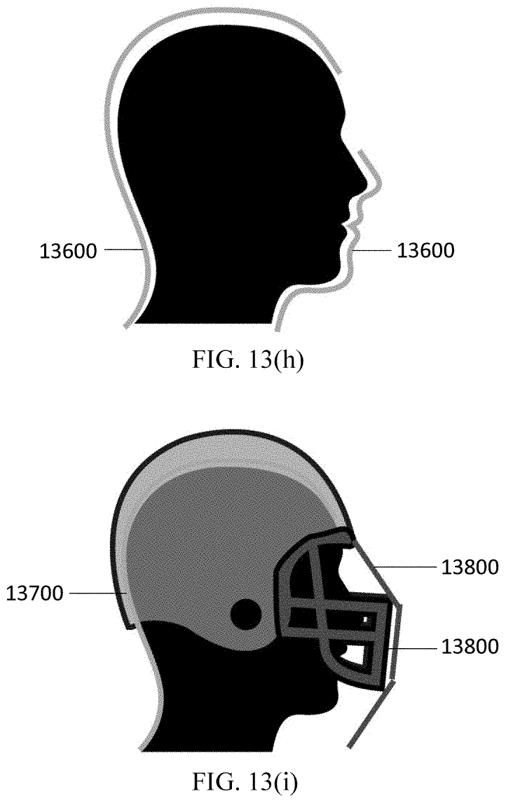

As shown in FIGS. 13(a) to 13(i), stabilizing contact areas found in apparel may serve as inspiration for designing head components of AVA or AKA embodiments. As shown in FIGS. 13(a) and 13(b), the stabilizing contact areas may be provided by a ring-like structure 13100 as found in a crown or a dome-like structure 13200 as found in a hat, wherein both of these structures may be combined into other head apparel, such as helmets, to help improve stability of a fit. As shown in FIGS. 13(c), 13(d), and 13(e), stabilizing contact areas may be provided by straps 13300 of various types, such as adjustable or elastic or other comparable straps, which may be used to supplement stability of head apparel or, in embodiments with a face-mask like structure, to help create a stable seal. Other embodiments may make use of head apparel that encompasses the head, like as shown in FIGS. 13(f) and 13(g). The stabilizing contact areas of these helmet-like structures may be created by a load-distributing point of contact 13400 that permits the helmet-like structure to rest upon the shoulders and upper torso or make use of straps 13500 that may or may not be incorporated into a soft-shelled garment. Head encompassing apparel may be soft-shelled, akin to anti-flash gear, wherein the stabilizing contact areas are provided by a soft encasing structure 13600 as in FIG. 13(h) or may be a hard-shelled structure, akin to a sporting helmet as like as shown in FIG. 13(i), wherein the stabilizing contact areas are provided by a hard encasing structure 13700 that may be accompanied by additional stabilizing support structures 13800 positioned in front of a user's face. According to an alternative embodiment, head encompassing apparel may be comprised of an upper hat-like portion and a drop-down curtain that encircles a user's face, akin in shape to a mosquito head net.

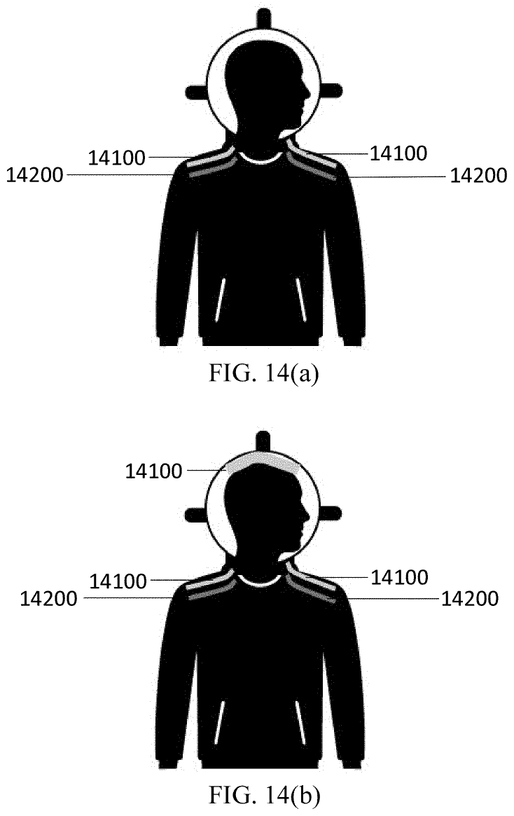

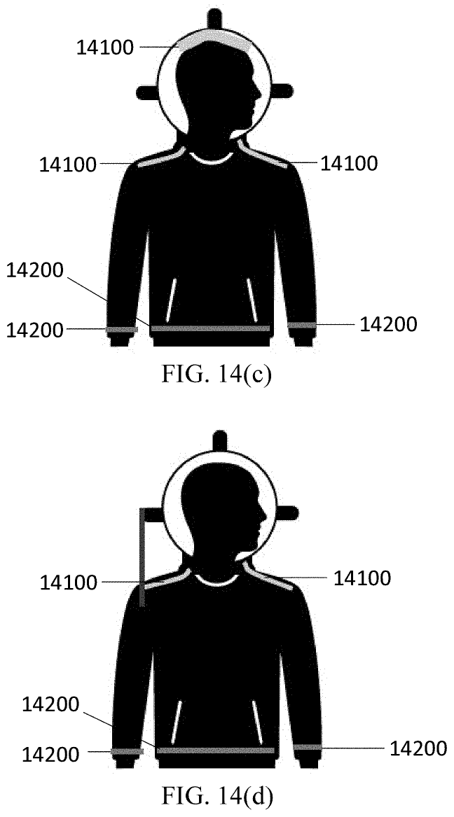

According to embodiments shown in FIGS. 14(a) to 14(d), weight bearing contact areas 14100 may be used to assist with fitting or securing a head component or apparel-like structure in conjunction with the use of seals 14200. Note that among embodiments of the invention, the weight bearing contact areas 14100 may, but do not necessarily, create the seals 14200. As such, a seal 14200 may be at the same location as a weight bearing contact area 14100, positioned near a weight bearing contact area 14100, or, as in the embodiments shown in FIGS. 14(c) and 14(d), at a location away from a weight bearing contact area 14100 such that the seals 14200 are created near a waist or wrist region.

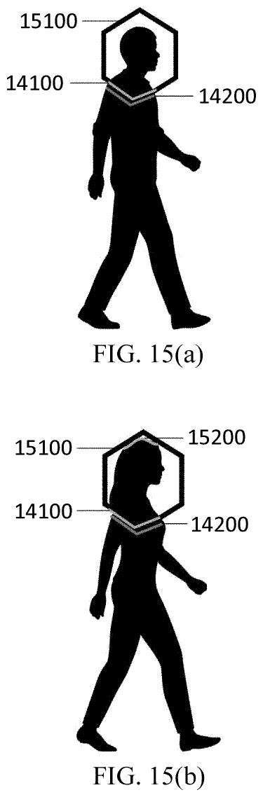

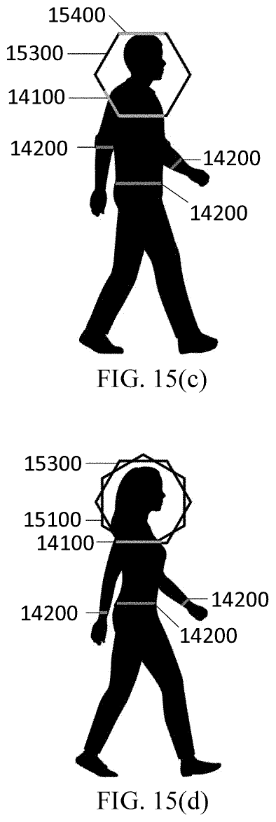

According to embodiments shown in FIGS. 15(a) to 15(d), designs of AVA or AKA may vary or be used in conjunction with one another to provide enhanced protection to a user. Particularly, an AVA embodiment may be comprised of a hard-shell helmet 15100 with no head support or contact, as shown in FIG. 15(a). An alternative embodiment shown in FIG. 15(b) uses a hard-shell helmet 15100 along with a hard-shell supportive head contact 15200 to assist with load bearing. The AKA embodiment shown in FIG. 15(c) capitalizes on a soft-shelled covering 15300 that includes a soft-shell supportive head contact 15400 at its top and seals 14200 near a user's waist and wrists. Lastly, a hard-shell helmet 15100 may be used in conjunction with a soft-shelled covering 15300 to provide enhanced protection, as shown in FIG. 15(d). Modular designs for embodiments incorporating both AVA and AKA components allow connections to be made from the conduits of a hard-shell helmet to the conduits of a soft-shelled covering, such as an upper body garment or covering.

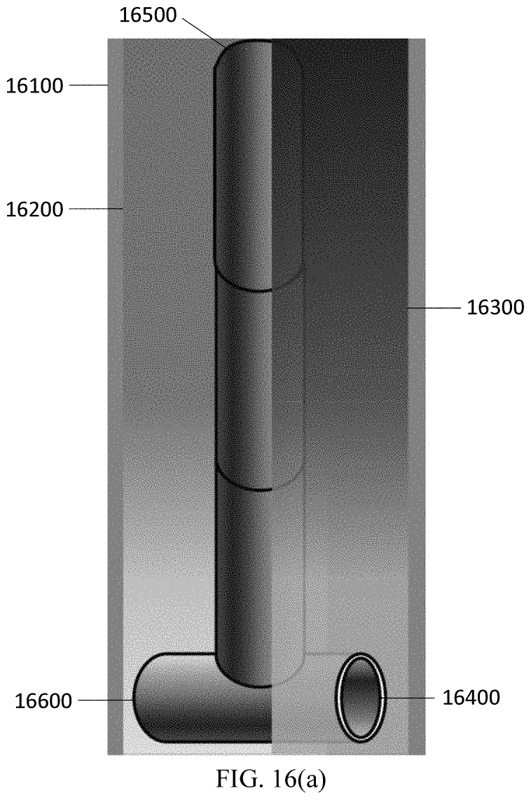

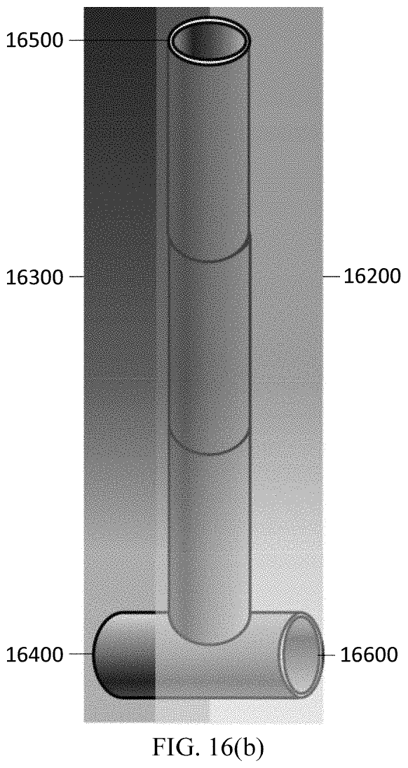

Another feature of integral importance in designing embodiments is determining how shells may be layered. According to an embodiment for which a frontal and rear view are shown in FIGS. 16(a) and 16(b) respectively, a user's skin 16100 is adjacent to an internal shell layer 16200 which is in turn adjacent to an external shell layer 16300. An inlet conduit portion 16400 enters the external shell layer 16300 to permit air intake, whereas an outlet conduit portion 16500 exits the internal shell layer 16200 to act as an outlet for delivering air to a user. Branched conduit portion 16600 may be blocked or connected to another filtration or conduit component, such as an air bladder for storing and further filtering air.

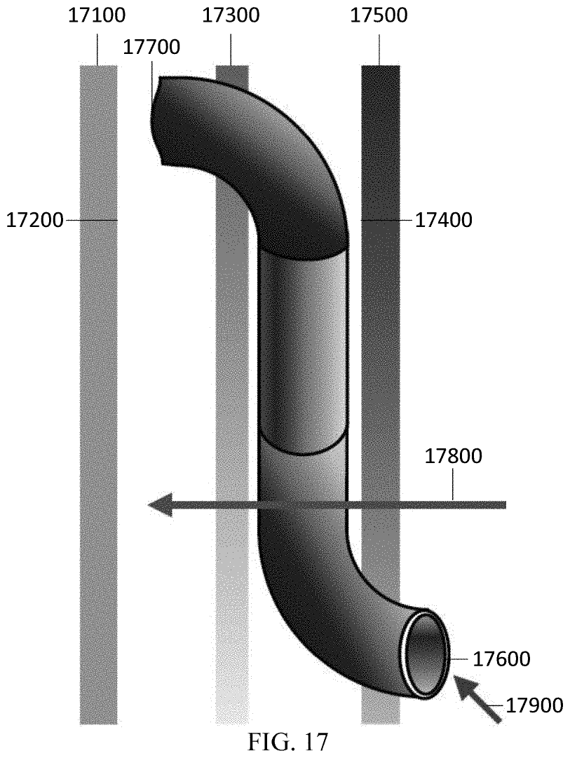

An alternative embodiment demonstrating shell layering is shown from a cross-sectional side view in FIG. 17. Therein, a user's skin 17100 defines one periphery of an internal cavity 17200 whose other periphery is defined by an internal shell layer 17300. The internal shell layer 17300 also defines one periphery of an intermediate cavity 17400 whose other periphery is defined by an external shell layer 17500. Furthermore, an inlet conduit portion 17600 enters the external shell layer 17500 to permit air intake, whereas an outlet conduit portion 17700 exits the internal shell layer 17300 to act as an outlet for delivering air to a user. A first airflow path 17800 permits air to traverse the external shell layer 17500 and internal shell layer 17300 and travel around the conduit structure prior to being available to a user. A second airflow path 17900 permits air to enter at the inlet conduit portion 17600 and exit at the outlet conduit portion 17700 prior to inhalation by a user. According to a further embodiment, internal cavity 17200 or intermediate cavity 17400 may be an air pocket. According to an alternative embodiment, intermediate cavity 17400 may contain supporting or insulating material, such as down commonly found in winter garments.

Bladders, Flaps, Pumps, and Other Functionalized Accessories

According to an embodiment, AVA or AKA may incorporate flaps, pouches, pockets, or air bladders in any combination to enhance functionality.

According to an embodiment, flaps may be incorporated as an approximately flat piece of material that is hinged or permanently or reversibly attached on one side and covers conduit infrastructure. According to an embodiment, flaps may be incorporated as an integral part of apparel, such as in AKA embodiments, or on top of the apparel itself, once more, as in AKA embodiments. In the case of integrated designs, the flap will have a seal equal to or greater than the rest of the garment. By contrast, non-integrated designs do not require such seal requirements, as conduits are located on the outside of the garment, like an AKA. Further, belt clips and other reversible means of attachment may be used to attach the conduits to the garment being worn by a user.

According to an embodiment, flaps may be incorporated into a face shielding structure to allow for a removable system wherein the face-shielding flap is positioned aside when not required. In such embodiments, the seal and release mechanism for the flap are designed to match environmental protection requirements.

According to an embodiment, pouches and pockets can be used to house air and allow access to air bladders. According to a further embodiment, reverse pockets in the shape of hands may be incorporated to permit safe access a body area, like a user's facial area, to manage daily tasks, habits, or actions, like dealing with an itch.

According to an embodiment, a bladder or pump may be incorporated to provide air storage, distribution, or filtering. Such components may operate by mechanical means, like by using body motions, without dependency on electronic motors or other power sources.

According to an embodiment, a bladder may be comprised of a filtering sponge structure that draws in air through an intake conduit to be reversibly stored in an internal cavity of the bladder. A bladder may be compressed to distribute stored air through a conduit network that channels air to a user. According to a further embodiment, the bladder has a self-filling mechanism wherein the bladder draws air into itself as it automatically returns to its uncompressed shape after compression. According to an embodiment, air bladders may be incorporated as a sponge-like structure sealed in a plastic containing membrane with an inlet and outlet tube.

In embodiments of the invention, a bladder and pump system may serve several important purposes. Firstly, a bladder may act as an air reserve that permits users to store some quantity of air that is subject to filtration before delivery to a user. Secondly, the ability to compress a bladder to facilitate the delivery of air to a user provides the user with control over their filtered air supply, in that the user may pump the bladder to deliver more air where circumstances create an increased air demand. For example, a user might activate the pump repeatedly to supply more air after physically exerting oneself. Third, an air supply can be subject to greater filtration as a result of sorption occurring within the bladder itself. Since air may be stored within a bladder prior to being delivered to and breathed by a user, an air reserve may be subject to longer filtration duration as it resides in the bladder and is subject to sorption.

According to an embodiment, a bladder or pump may be integrated into AVA or AKA or exist as a modular structure that is separable from the rest of an embodiment. Where separable, bladder and pump systems may be interchanged with those of different designs, structures, or properties to suit the requirements of a particular use case scenario. For example, a first bladder suitable for sorption of a first contaminant may be exchanged for a second bladder suitable for sorption of a second contaminant if a user moves from an area that presents a high risk of exposure to the first contaminant to an area that presents a high risk of exposure to the second contaminant. Conduits comprising a conduit system for filtration and delivery of air to a user may be similarly exchanged.

According to an embodiment, a bladder and pump system may be activated by natural body movements, unique body movements, or an automatic control system. Natural body movements, like the movement of one's legs or arms while walking or running, may be used to activate the pump and drive air through the system. Alternatively, unique body movements that would not naturally occur may be used to activate the pump, such that inadvertent activation does not occur as a result of a user making natural body movements. In this regard, unique means of activation may be devised and used, like manual compression of a bladder with a user's hands or by using upper torso movements. As a further example, a bladder and pump system incorporated into a jacket-like AKA may be activated by a self-hugging body motion. Since self-hugging is not a body movement that would commonly occur in a user's daily activities, the chance of inadvertent activation of the system is bypassed. Thus, users can perform a self-hugging body motion to compress bladders comprising AKA and release the air stored in an air bladder on demand. According to an embodiment, a combination of natural body movements, unique body movements, or an automatic control system may be used to activate a bladder and pump system.

According to an embodiment, there are three primary areas that may be especially useful in pumping air from a bladder to a user. The first is the armpit area, which would allow users to pump air using arm motions. The second is the waist area, wherein a bladder secured near a user's waist can be pumped by the user's hands through a flap or pocket access. The third is the feet area, wherein pumping may occur during walking.

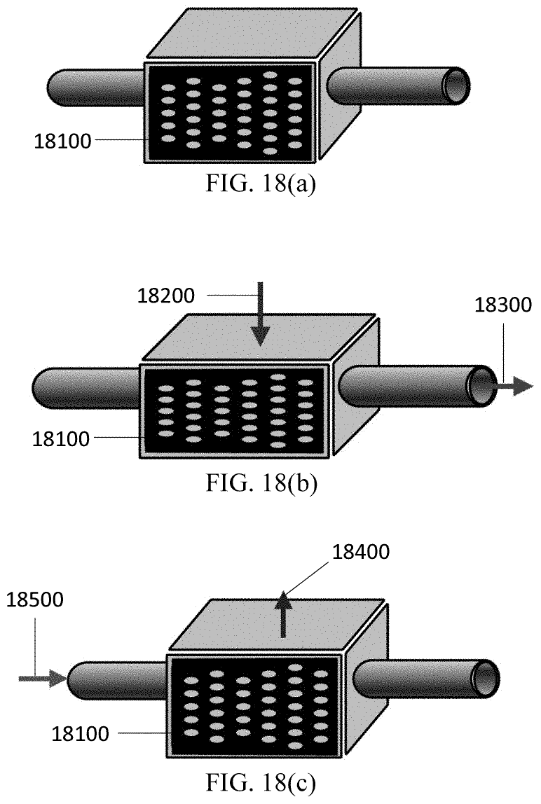

According to an embodiment, pouch and air bladder functionality is controlled by applying a compressive force. According to an embodiment shown in FIG. 18(a), an air bladder may contain foam-like filtering materials 18100 and may be positioned around the waist, armpit, or feet areas of a user. As shown in FIG. 18(b), subjecting an air bladder to a compressive force 18200 facilitates air efflux 18300 from the air bladder and into a connected conduit network that may direct the air efflux 18300 towards a user's head area. As shown in FIG. 18(c), a restorative force 18400 can cause the air bladder to regain its original form after compression and create an air influx 18500. According to a further embodiment, linear airflow may be attained through the use of tubular valves.

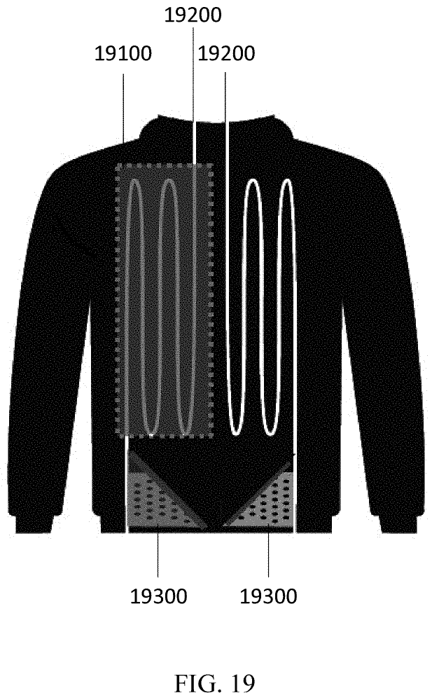

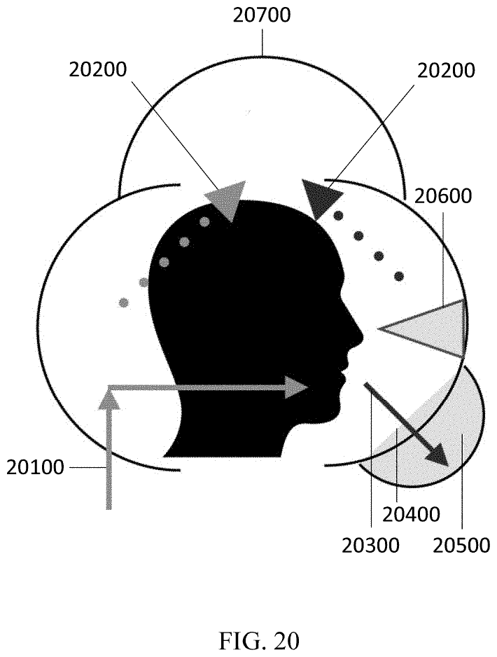

According to an embodiment, flaps and pouches may be incorporated to permit easy access to conduits or the operation of bladders. According to an embodiment shown in FIG. 19, a flap 19100 covering at least one tubular structure 19200 may be partially detachable, flipped, or opened to access at least one tubular structure 19200. Also shown in FIG. 19 is the incorporation of a pocket or pouch area that can be accessed by the hands of a user such that the user can squeeze air bladders 19300 to permit manual release of air reserves. Such manual release of air may be done when the user requires an extra supply of air, for example, in response to increased oxygen demands during strenuous physical activity or exercise.

According to an embodiment shown in FIG. 20, a preferred air influx pathway 20100 permits air to enter a head area from an area near the back of the head where an AVA is incorporated or from the upper body region where an AKA is incorporated. Ambient airflow 20200 may circulate the head area and may be breathed in or vented out. A preferred exhalation pathway 20300 and inner shell 20400 may comprise a filtering area 20500 for exhaled area. Furthermore, a deflector 20600 may be incorporated to facilitate airflow downwards and away from a user's facial area. According to a further embodiment, a top of head area 20700 may be vented, especially where an AVA is incorporated.

Materials, Maintenance, and Use Considerations

In designing embodiments, deciding upon the appropriate comprising materials is an especially important task. With respect to construction of embodiments of the invention, commercially available textiles and other components may be adequate for use in constructing apparel, helmet, tubing, modules, and other AVA or AKA components. According to an embodiment, materials are evaluated and gauged for use based at least in part on their functional properties, such as sorption, permeability, filtration, ability to generate electrostatic forces, and other comparable properties.

According to an embodiment with a hard-shell helmet component, the primary function of the hard-shell helmet component may be structural support and selective permeability, such that parts of the helmet may be vented to dissipate heat and water vapor, and it may be constructed of light weight materials such as plastic or fiberglass and with few contact points on the head or shoulders of a user.

According to an embodiment, conduits, including tubing, and pouches may be of an impermeable material, such as plastic, to isolate air. Tubing may be approximately circular but may also be of a flattened shape and designed to prevent pinching. Tubing may be affixed to a garment using grommets and may be covered with material for filtering as well as for aesthetic purposes. Other attachment methods may be used, for example magnets and sewing. Although the diagrams show the tubing on the outside, the tubing itself may be incorporated into the shell structure. Air bladders may consist of an impermeable material containing memory foam that will release air when squeezed and draw air in afterwards.

According to an embodiment, accessories such as connectors and valves may be incorporated and may be comprised of plastic or metal.

According to an embodiment, a driving principle behind the design of AVA and AKA is to minimize disposables and maximize reuse. As such, cleaning and maintenance of embodiments is a key consideration. Normal means of washing and cleaning helmets and clothing may be adequate for AVA or AKA, and tubes ought to be dried after washing such that tubes are empty of water or moisture that may pose a risk of compromising sorption. Flaps may be used to create a pouch and may be incorporated so that tubing can be accessed, removed, and treated (washed and dried) separately and reattached to a garment or helmet component. Such flaps may be incorporated based on user needs and usage, such that embodiments may be designed with greater accessibility if an AVA or AKA is directed to being used regularly or in high contaminant areas, thereby causing a greater need for access to and regular cleaning of tubing.

Modules and parts comprising embodiments may require separate treatment if they contain a specialized adsorbent, like silica gel, activated charcoal, or zeolites. This may involve brine soaking or heating in an oven or microwave.

Embodiments may incorporate a virucide, antibacterial, or other antimicrobial or anti-contaminant compound. Such compounds, if safe for use as a topical application, may be incorporated into creams and shampoos used in conjunction with AVA or AKA. According to an alternative embodiment, a sticky substance may be applied to a user's skin to assist in capturing viral, bacterial, fungal, protozoan, microbial, particulate, and xenobiotic contaminants at a location that is harmless to a user.

In designing embodiments, it is also important to account for differences that may exist among users. A user's phenotype, inclusive of height, shape, and immune system, may be accounted for in designing embodiments of the invention, such that each embodiment is especially suited for the user's characteristics. This may include identifying what activities a prospective user regularly undertakes that may exposure them to contaminants, what sort of environmental conditions they regularly occupy, and any prospective immune system risks. Embodiments of the invention may use a modular design to help provide such versatility in use.

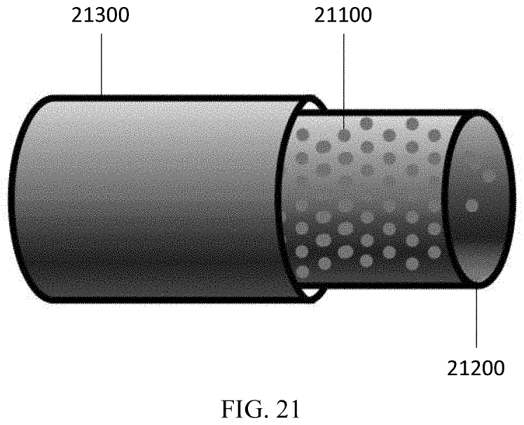

According to an embodiment, electronic equipment may be incorporated for the purpose of disinfecting air prior to breathing. In doing so, a volume of air may be encapsulated and treated, wherein such a volume approximately corresponds to the tidal volume of a user. Electromagnetic radiation may be used to achieve this end, such as by subjecting the volume of air to ultraviolet light before delivery to a user. According to an embodiment shown in FIG. 21, an electromagnetic radiation source 21100 may be incorporated into a conduit such that electromagnetic radiation is released upon air passing through an internally defined chamber 21200. An outer tube structure 21300 may be comprised of an opaque material to protect the user from the electromagnetic radiation or may be comprised of reflective material to intensify the electromagnetic radiation within the internally defined chamber.

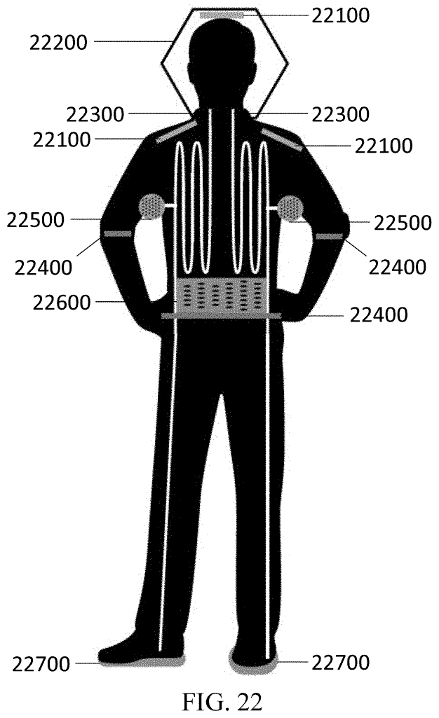

As shown in FIG. 22, an embodiment may be comprised of an AKA with accessories. Particularly, there may be a weight bearing area 22100 near the top of a soft-shelled head component 22200, with further weight bearing areas 22100 located near the shoulders of a user. A tubular network 22300 may be integrated and run from an intake location near a user's feet and terminate near a user's face to facilitate air delivery. Seals 22400 may be located near a user's elbows and waist, while arm pit air bladders 22500 and a belt area air bladder 22600 may act as pumpable air reserves. Furthermore, pumpable foot bladders 22700 may also be activated to facilitate air supply to a user.

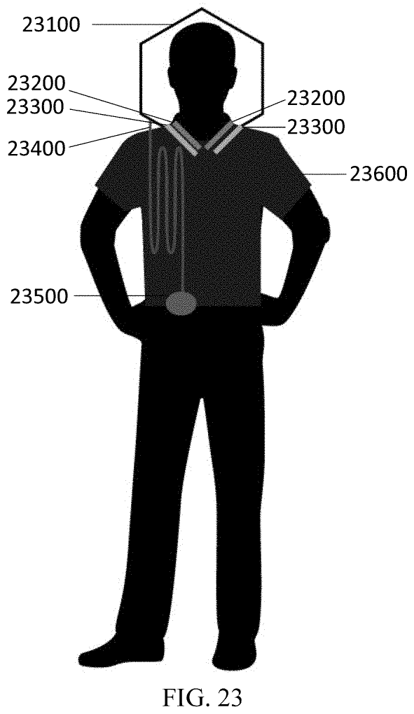

As shown in FIG. 23, an embodiment may be comprised of an AVA with accessories. Particularly, there may be a hard-shelled head component 23100 with seals 23200 created at weight bearing areas 23300 near the base of the hard-shelled head component 23100. A tubular network 23400 independent of user apparel may be connected to the hard-shelled head component 23100 such that air may be delivered from a location away from a user's head to an internal chamber defined by the hard-shelled head component 23100. A tube clip 23500 may be used to reversibly secure a portion of the tubular network 23400 to a user's shirt 23600.

Early Prototypes

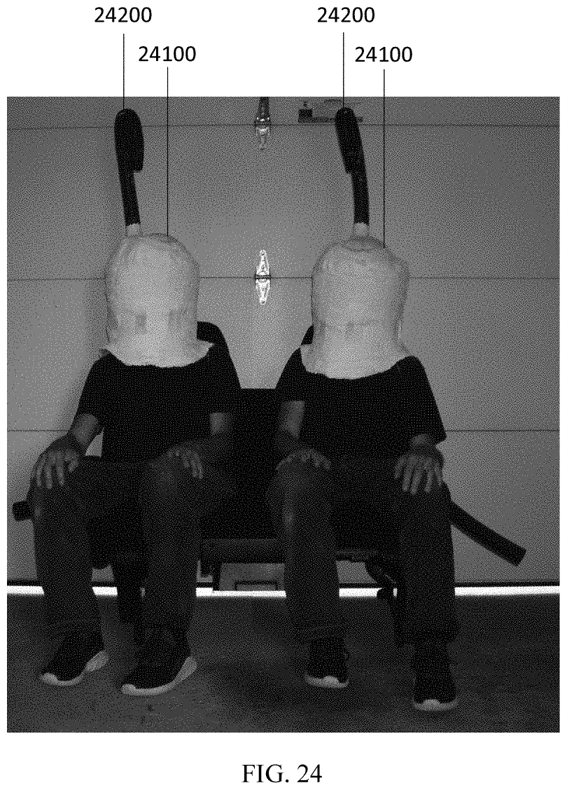

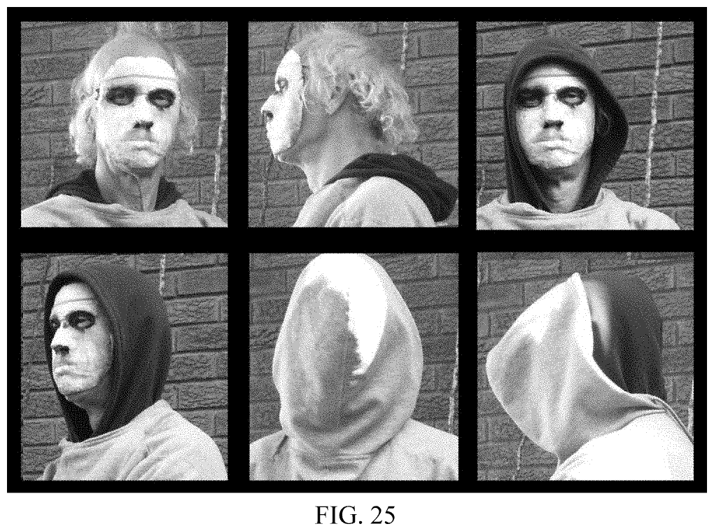

According to an embodiment shown in FIG. 24, an AVA may be comprised of a hard-shelled encasing 24100 connected to an airflow conduit 24200. According to an embodiment shown in FIG. 25, an AKA may resemble a series of hooded flaps affixed to apparel, such that the hooded flaps may be engaged to cover a user's head in a soft-shelled encasing.

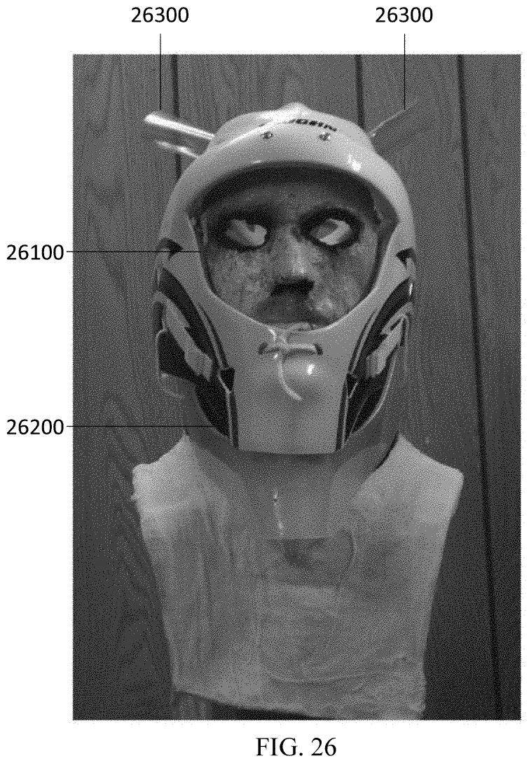

According to an embodiment shown in FIG. 26, an AVA may resemble a helmet structure wherein a top facial area 26100 is clear and a lower facial portion 26200 traps contaminants from exhaled air. Air conduits 26300 for air intake and venting may be positioned near the top of the helmet structure, with a seal created around the shoulders and chest of a user to minimize wobbling of the helmet structure.

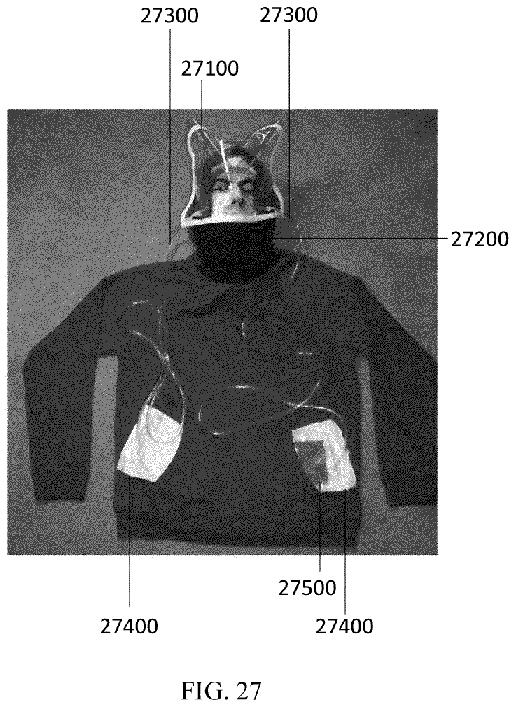

According to an embodiment shown in FIG. 27, an AKA may be comprised of a clear top facial area 27100 with a lower facial area that comprises an exhalation filtration zone 27200. Tubing 27300 may permit air intake away from a user's head and may follow lateral lines. Air bladders 27400 may be incorporated to provide an air reserve and may be further comprised of an air bladder filter 27500 to provide a filter filled bladder. Valves may be incorporated such that, with the appropriate body motions, air bladders 27400 may be compressed to push air into the system. Restoration of the bladder shape draws air in, and bladders may be comprised of memory plastic or foam such that bladder shape is naturally restored to an expanded configuration after compression. Tubing 27300 may be segmented and modular to allow for filtering stations and the use of multiple filters to create filtration gradients.

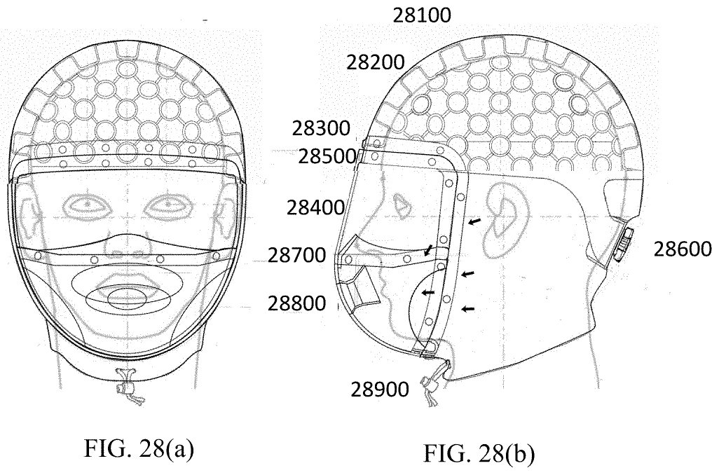

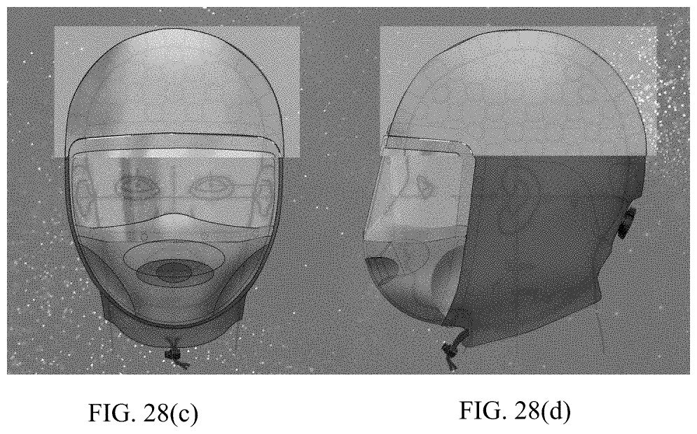

According to an embodiment shown in FIGS. 28(a) to 28(d), an AKA may lack sorption tubing and may be comprised of a flexible molded structure 28100, which comfortably supports washable fabric filter 28200 away from a user's head. Preferably, the flexible molded structure 28100 comprises polypropylene and the washable fabric filter 28200 comprises spunbond non-woven polypropylene. A ratchet adjustment 28600 allows the flexible molded structure 28100 to fit a wide variety of head sizes and shapes. The washable fabric filter 28200 is held in place with a series of magnets 28300 sewn or heat sealed into the fabric. A half face transparent visor 28400 is also attached to the flexible molded structure 28100 with magnets so it can easily be removed. Preferably, the visor 28400 comprises polycarbonate. A molded silicone lower face piece, also held to the flexible molded structure 28100 structure with magnets 28500, has an integral shield 28700 over the nose that keeps condensation and carbon dioxide away from the vision space. The rear of the lower face piece is open to bring air in from the filter area. Venturi vent allows air to be expelled from the nose and mouth through the one way integral exhaust valve 28800. A draw string 28900 seals the lower area of the head gear but can expand to easily fit over the user's head.

Various embodiments of the invention have been described in detail. Since changes in and or additions to the above-described best mode may be made without departing from the scope of the invention, the invention is not to be limited to those details but only by the appended claims. Section headings herein are provided as organizational cues. These headings shall not limit or characterize the invention set out in the appended claims.

What is claimed is:

1. A wearable protective device, comprising:
a breathing chamber;
a conduit network attached to the breathing chamber at a first conduit network terminal portion such that the breathing chamber is in fluid communication with the first conduit network terminal portion;
a second conduit network terminal portion of the conduit network in fluid communication with an air source; and
a sorption structure within the conduit network.

2. The wearable protective device of claim 1, wherein the breathing chamber is a hard-shelled headpiece structure.

3. The wearable protective device of claim 1, wherein the breathing chamber is a soft-shelled apparel structure.

4. The wearable protective device of claim 3, wherein the soft-shelled apparel structure is comprised in part of an adjustable hood structure that can be transitioned between an activate encasing configuration and an inactive storage configuration.

5. The wearable protective device of claim 1, wherein the breathing chamber is comprised of impermeable, semipermeable, or permeable materials.

6. The wearable protective device of claim 1, wherein the first conduit network terminal portion is attached to the breathing chamber at a back portion of the breathing chamber or a side portion of the breathing chamber.

7. The wearable protective device of claim 1, wherein the second conduit network terminal portion is in fluid communication with the air source at a location distal to the breathing chamber.

8. The wearable protective device of claim 1, wherein the breathing chamber has a plurality of structural layers, between which is at least one cavity that may be an air pocket or contain a supporting material or an insulating material.

9. The wearable protective device of claim 1, wherein the sorption structure is a viral trap, a bacterial trap, a fungal trap, a protozoan trap, a microbial trap, a particulate trap, a xenobiotic trap, or a contaminant trap.

10. The wearable protective device of claim 1, wherein the sorption structure is comprised of an adhesive, an obstruction element, a filter, a diameter narrowing element, a flow reversal conduit element, a high-surface area element, a silica gel, a zeolite, an activated carbon element, a desiccant, a protein, a nucleic acid, an antibody, a moiety, a functional group, a polymer, a virucide, an antibacterial chemical, an antimicrobial chemical, an anti-contaminant chemical, a chemical generating Van der Waals forces, a material generating electrostatic forces, a chemical with hydrophilic characteristics, a chemical with hydrophobic characteristics, a polar chemical, or a non-polar chemical.

11. The wearable protective device of claim 1, wherein the sorption structure is comprised of a plurality of sorption steps that creates a sorption gradient.

12. The wearable protective device of claim 1, wherein the breathing chamber, the conduit network, or the sorption structure is of a modular design.

13. The wearable protective device of claim 1, further comprising an electromagnetic radiation source element, a sound wave generating element, an electrostatic element, or a diathermy element within the conduit network.

14. The wearable protective device of claim 13, wherein the conduit network is comprised at least in part of an opaque material or a reflective material.

15. The wearable protective device of claim 1, further comprising an air bladder in fluid communication with the conduit network.

16. The wearable protective device of claim 15, further comprising an air bladder sorption structure element within the air bladder.

17. The wearable protective device of claim 15, wherein the air bladder is comprised of a compressible material that may generate an expansive force which automatically returns the compressible material to an expanded configuration to draw in ambient air after compression.

18. The wearable protective device of claim 1, further comprising a fluid flow control element, like a valve, a vent, a pressure regulator, a motor, or other comparable fluid flow control element.

19. The wearable protective device of claim 1, wherein the conduit network is comprised of a single common conduit to provide a bidirectional airflow path.

20. The wearable protective device of claim 1, further comprising:
an auxiliary conduit network attached to the breathing chamber at a first auxiliary conduit network terminal portion such that the breathing chamber is in fluid communication with the first auxiliary conduit network terminal portion;
a second auxiliary conduit network terminal portion of the auxiliary conduit network in fluid communication with the air source; and
an auxiliary sorption structure within the auxiliary conduit network;
wherein the conduit network functions as an air intake pathway and the auxiliary conduit network functions as an air outlet pathway to provide a unidirectional airflow path from the second conduit network terminal portion through the conduit network, the breathing chamber, and the auxiliary conduit network to the second auxiliary conduit network terminal portion.
